(19) United States
(12) Patent Application Publication
(10) Pub. No.: US 2009/0234852 A1
(43) Pub. Date: Sep. 17, 2009

(54) SUB-LINEAR APPROXIMATE STRING MATCH

(75) Inventor: Jordi Mola, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/049,386

(22) Filed: Mar. 17, 2008

(51) Int. Cl. G06F 7/06

(52) U.S. Cl. 707/6; 707/E17.014

(57) ABSTRACT

Computerized search problems can be performed more quickly, efficiently and effectively by utilizing a database of potential matching items and associated similar items which are grouped, or otherwise related, by their distance, measured in change, from their respective potential matching item. An input item requiring a search for a match and, if necessary, one or more similar input items generated by making a change to the input item are compared with sub-linear effort to the database. In this manner, matches in the database within an acceptable distance, measured in change, can be quickly and effectively identified for an input item.

### BACKGROUND

Computers and computer-based devices, e.g., BLACKBERRY® hand-held devices, computer-based cell phones, etc., collectively referred to herein as computing devices, can facilitate internet searches, by taking words and/or symbols supplied by a user and returning one or more web page references that contain one or more of the supplied words and/or symbols.

For example, various search engines scan existing web pages for the words they contain and create and/or update indexes that catalog which words are contained on which web pages. When a user requests a web search with a query of one or more words, a search engine searches the index and, if found, returns an identification of one or more web pages that each contain one or more of the query words and which are deemed most responsive to the query.

There are, however, vast numbers of words on vast numbers of existing web pages, rendering the indexes extremely large. The number of index entries, resultant from the number of web pages, is time consuming to scan for any one query, and in general, the possible number of responses to any particular query is large.

To help expedite web searches and ensure meaningful results are returned to a user, search engines can order web pages. In this manner, when an index is created web pages are prioritized, based on one or more characteristics, in the index. One such characteristic is the meaningfulness of a web page measured by the number of other web pages that link to it. Search engines can then limit an index search to a predefined number of responses, or can limit the time a search is performed and return those responses identified in the time limit. As the web pages are prioritized in the index based on at least one measure of meaningfulness, the search engine can limit its search and still expect to return web pages that are responsive to a user's query.

Computing devices are also increasingly used to perform CATs (computer aided translations). Computing devices are used to translate software, web pages, etc., from one language to another, in order to effectively reduce the costs of translation. In general, a computing device takes as an input a string of one or more words, referred to herein as a token string for ease of explanation. The computing device then attempts to match the input token string to at least one token string stored in a database structure, such as, but not limited to, an index, lookup table, hash table, etc., by scanning the database structure. If an identical token string is found in the database structure for the input token string, the translation identified with the database structure token string is the correct translation and is used.

If no identical database token string exists for the input token string, a similar database token string may be acceptable for use in translating the input token string. A similar token string is a token string that differs by a defined distance from the original token string where distance is measured in tokens, e.g., sentences, words, etc.

As with web searches, however, there are generally a vast number of token strings stored in a database structure for effecting a translation. The sheer size of the database structure renders even simple translation exercises expensive, as the number of database entries makes translation searches time consuming. Allowing for similar matches between an input token string and a database token string, while enabling computer aided effective translations to be generated, increases the expense of the translation exercise. Moreover, database entries for translation exercises cannot be prioritized as web pages are for web searches, as any useful match is inextricably dependent on the input, and cannot be measured by independent criteria.

Thus, it would be desirable to reduce the cost of computer aided translations, i.e., the time and energy to perform such translations, so that it is less than current linear costs dictated by the size of the database structure used to render the translations. It would further be desirable to define a search such that the same search methodology can effectively be used for other problems that can be solved with exact or similar solutions, e.g., DNA sequencing identification, fingerprint identification, face recognition, address identification, etc.

### SUMMARY

This summary is provided to introduce a selection of concepts in a simplified form that are further described below in the Detailed Description. This summary is not intended to identify key or essential features of the claimed subject matter, nor is it intended to be used as an aid in determining the scope of the claimed subject matter.

Embodiments discussed herein include methodology for generating a database to effect sub linear token string matching. In an embodiment strings of one or more tokens, i.e., token strings, to be included in a database, i.e., database token strings, are processed into sets of similar database token strings and each set is stored, or otherwise grouped or associated, together in the database. In an embodiment a similar database token string is a database token string that is lacking one or more tokens.

Embodiments discussed herein also include methodology for using a generated database of token strings and derived similar token strings to identify a solution, e.g., a translation, street address identification, fingerprint identification, etc., for an input token string. In embodiments an input token string is compared against the database token strings and derived similar database token strings for a match. In embodiments an input token string is processed to generate one or more similar input token strings, where a similar input token string is an input token string that is lacking one or more tokens. In an embodiment derived similar input token string(s) are compared against the database token strings and derived similar database token strings for a match.

In embodiments if a match is found for an input token string or similar input token string a solution associated with the match is used for the input token string.

### BRIEF DESCRIPTION OF THE DRAWINGS

These and other features will now be described with reference to the drawings of certain embodiments and examples which are intended to illustrate and not to limit the invention, and in which:

FIG. 1 depicts examples of similar token strings of where the tokens are words.

FIG. 2 is an embodiment database for sub linear token string matching.

FIG. 3 depicts an exemplary index of two token strings of words for sub linear token string matching.

FIGS. 4A-4J each depict an example of identifying a solution for an input token string of words using the exemplary database of FIG. 3.

FIGS. 5A-5F illustrate an embodiment logic flow for creating and using a database for sub linear token string matching.

FIG. 6 is a block diagram of an exemplary basic computing device system that can process software, i.e., program code, or instructions.

### DETAILED DESCRIPTION

In the following description, for purposes of explanation, numerous specific details are set forth in order to provide a thorough understanding of the present invention. It will be apparent, however, to one skilled in the art that the invention may be practiced without these specific details. In other instances, well-known structures and devices are shown in block diagram form in order to avoid unnecessarily obscuring the invention. Any and all titles used throughout are for ease of explanation only and are not for use in limiting the invention.

Current known search methods for computer aided search problems, e.g., computer aided translation (CAT), generally cost O(N), where the cost of the search for a matching database token string to an input token string grows at the same rate as the size of the data searched, i.e., the search space, or database. To reduce the cost O(N) of a search to O(log N) sub linear search efforts are effected to reduce processing while still enabling meaningful results. In an embodiment one search problem allowing for exact and similar match results is recast into one or more search problems for exact match results.

With reference to translation search problems, in an embodiment a database contains a collection of one or more database token strings. In embodiments a token can be any defined subset of a whole, e.g., but not limited to, for translation problems, a word and/or a phrase and/or a sentence and/or a paragraph and/or a chapter of two or more paragraphs, etc. Thus, in embodiments for translation problems an input token string can be a word or a phrase or a sentence or a paragraph or a chapter, etc. In embodiments for translation problems a database token string can be a word or a phrase or a sentence or a paragraph or a chapter, etc.

In alternative embodiments a database contains a representation of the tokens of a database token string, such as, but not limited to, numbers representing tokens, symbols representing tokens, a hash representation of each database token string, etc.

In an embodiment each database token string points to, or otherwise references, a solution. Thus, in an embodiment for translation problems, each database token string points to, or otherwise references, a translation of the database token string, i.e., to another language.

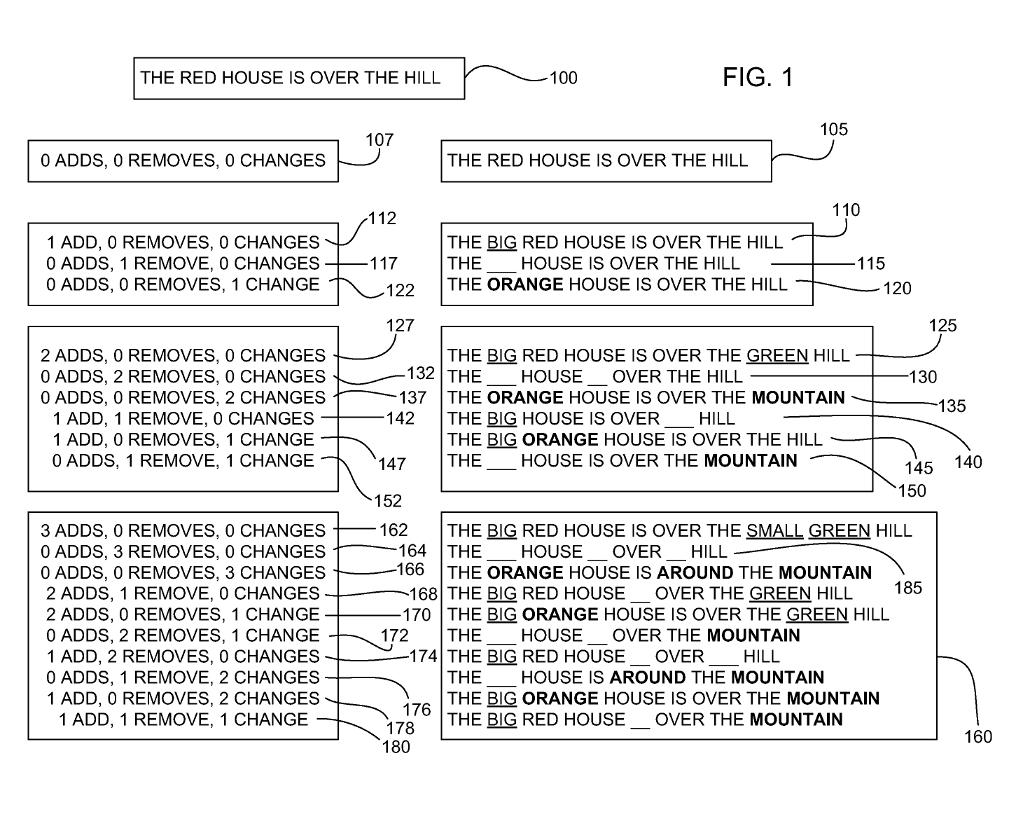

In an embodiment for translation problems an input string of tokens, e.g., an input string of one or more words, also referred to as an input token string, to be translated can have an exact match in a database. Referring to FIG. 1 for example, if an input token string to be translated is the sentence “The red house is over the hill” 105 and the database contains the database token string “The red house is over the hill” 100 this is an exact match. The input sentence 105 has no additional words (zero adds), no deleted words (zero removes) and no changed words 107 from the database token string 100. Thus, the translation associated with the database token string 100 is correct for the input sentence 105.

For translation search problems in an embodiment similar can be an acceptable solution. In an embodiment similar is defined as an acceptable distance between an input token string and a database token string where distance is measured in token, e.g., sentence or word, alterations. In some embodiments similar is defined as a distance of one, where the input token string can have one token add, one token remove or one token change from a database token string and the database token string is still deemed a match.

For example, and again referring to FIG. 1, if the input token string to be translated is the sentence “The big red house is over the hill” 110, there is no exact match in the database, which for this simplistic example contains the sole database token string “The red house is over the hill” 100. However, the input sentence 110 only contains one token add 112, i.e., the addition of the word “big” to the database token string 100. Thus, input sentence 110 is similar by a distance of one to the database token string 100. In this example, in embodiments where similar is defined as a distance of one the database token string 100 is a match to the input sentence 110 and the identified translation for the database token string 100 is used for the input sentence 110.

As another example, if the input token string to be translated is the sentence “The house is over the hill” 115, there is no exact match in the database containing the sole token string “The red house is over the hill” 100. The input sentence 115, however, has only one token remove 117, i.e., it is missing the word “red” from the database token string 100. Thus, as in the prior example, input sentence 115 is similar by a distance of one to the database token string 100. In this example in embodiments where similar is defined as a distance of one, the database token string 100 is a match to the input sentence 115 and the identified translation for the database token string 100 is used for the input sentence 115.

As a final example, if the input token string to be translated is the sentence “The orange house is over the hill” 120, there is no exact match in the database containing the sole token string “The red house is over the hill” 100. The input sentence 120, however, has only one token change 122, i.e., “orange” replaces “red,” from the database token string 100. Thus, input sentence 120 is similar by a distance of one to the database token string 100. In this example in embodiments where similar is defined as a distance of one the database token string 100 is a match to the input sentence 120 and the identified translation for the database token string 100 is used for the input sentence 120.

In some embodiments similar is defined as a distance of two where the input token string can have two token adds 127, two token removes 132, two token changes 137, one token add and one token remove 142, one token add and one token change 147, or one token remove and one token change 152 from a database token string and the database token string is still deemed an acceptable match to the input. In these embodiments similar also includes input token strings with a distance of one, i.e., one token add 112, one token remove 117 or one token change 122, from a database token string, as previously described.

For example, if the input token string to be translated is the sentence “The big red house is over the green hill” 125, there is no exact match to the sole database token string “The red house is over the hill” 100. The input sentence 125 contains two token adds 127, i.e., the additional words “big” and “green,” from the database token string 100. Thus, input sentence 125 is similar by a distance of two to the database token string 100. In embodiments where similar is defined as a distance of two the database token string 100 is a match to input sentence 125 and the translation for the database token string 100 is used for input sentence 125.

As another example, the input token string “The house over the hill” 130 has no exact match in the database containing the sole token string “The red house is over the hill” 100. The input token string, i.e., sentence 130, contains two token removes 132; it is missing the words “red” and “is” from the database token string 100. Thus, input sentence 130 is similar by a distance of two to the database token string 100. In embodiments where similar is defined as a distance of two the database token string 100 is a match to input sentence 130 and the translation for the database token string 100 is used for input sentence 130.

As yet another example, the input token string “The big orange house is over the hill” 145 has no exact match in the database containing the sole token string “The red house is over the hill” 100. The input token string, i.e., sentence 145, contains one token add and one token change 147; it contains the additional word “big” and it replaces “red” with “orange” from the database token string 100. Input sentence 145 is similar by a distance of two to the database token string 100. Thus, in this example in embodiments where similar is defined as a distance of two the database token string 100 is a match to input sentence 145 and the translation for the database token string 100 is used for input sentence 145.

FIG. 1 also contains examples of an input token string 135 with two token changes 137 from the database token string 100, an input token string 140 with one added token and one removed token 142 from the database token string 100, and an input token string 150 with one removed token and one changed token 152 from the database token string 100.

In some embodiments similar can be defined as a distance of three where the input token string can have three token adds 162; three token removes 164; three token changes 166; two token adds and one token remove 168; two token adds and one token change 170; two token removes and one token change 172; one token add and two token removes 174; one token remove and two token changes 176; one token add and two token changes 178; or, one token add, one token remove and one token change 180 from a database token string and the database token string is still deemed a match to the input token string. In these embodiments similar also includes input token strings with a distance of two and with a distance of one from a database token string.

In FIG. 1 various examples of input token strings 160 are similar to the database token string 100 in embodiments where similar is defined as a distance of three.

In other embodiments similar can be defined as a distance of four, five, etc. from a database token string. However in many embodiments similar is generally limited to no more than a distance of three, or even two, from a database token string in order for the provided solution to be meaningful.

For translation problems input token strings can have differences from database token strings in respects other than additional, removed or changed words. For example, but not limited to, input token strings can have additional, less or different punctuation and/or type fonts and/or token colors and/or emphasis, e.g., bolding, italicizing, etc., collectively referred to herein as token looks, from database token strings.

In an embodiment for translation problems token looks are removed, or otherwise ignored, from input token strings prior to exact and similar database match searching, and then added back in, or otherwise dealt with, in a post processing step after any exact or similar database token strings are identified. In this embodiment token looks are post processed to reduce the scope of the translation problem as token looks alterations, i.e., token looks changes,

In an embodiment database token strings with existing translations to be included in a computer aided translation (CAT), or search, database are used to generate various similar database token strings reflecting various distances from the original database token string. In an embodiment original database token strings are stored, or otherwise grouped or associated, together in a search database. In an embodiment the generated similar database token string(s) are stored in the search database with reference to their distance from the database token string from which they were generated. In an embodiment similar database token strings with a distance of one from the database token string from which they were generated are stored, or otherwise grouped or associated, together in the search database. Likewise, in an embodiment similar database token strings with a distance of two from the database token string from which they were generated are stored, or otherwise grouped or associated, together in the search database, and so on.

In an embodiment the group of original database token strings is denoted a data bucket, as further discussed below. In an embodiment each group of similar database token strings with the same distance from the database token strings from which they were generated are also denoted a data bucket, as further discussed below.

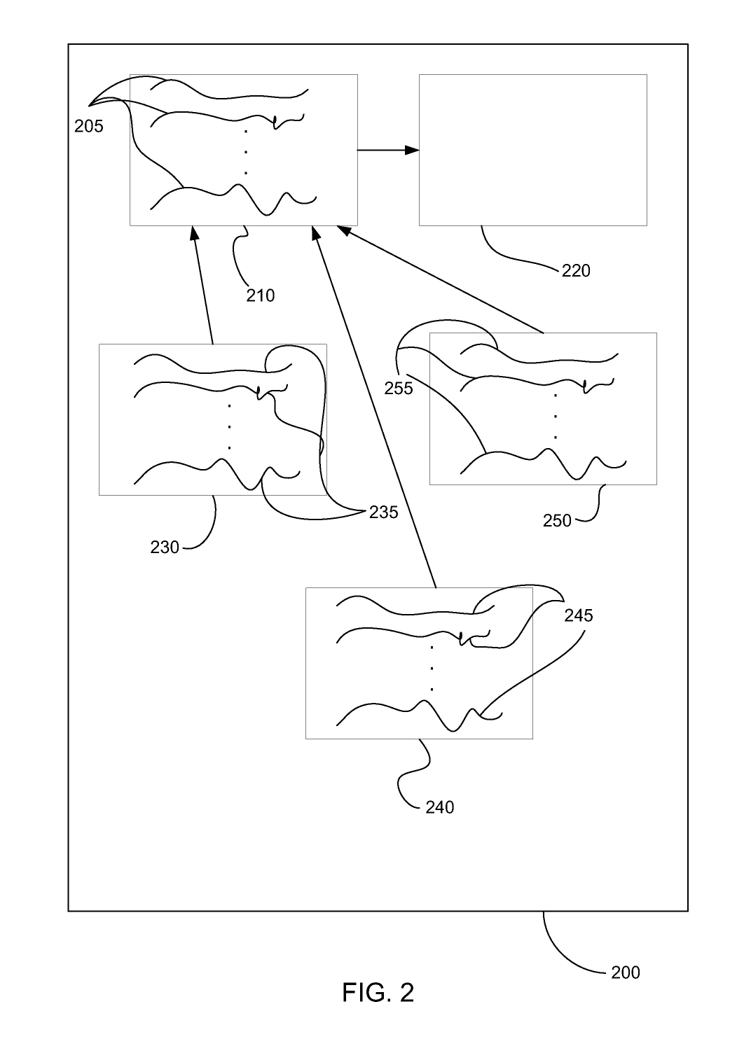

FIG. 2 depicts an embodiment database 200 for use in computer aided translations (CAT). In the database 200 database token strings 205 for which a translation exists are stored, or otherwise grouped, associated or referenced, collectively referred to herein as stored, as a first, D0, data bucket 210. In an embodiment for CAT problems each of the database token strings 205 contains all the words, in the correct order, for which an accompanying translation exists. Referring to FIG. 1, in this embodiment database token string 100, as an original, unaltered, database token string is stored in a first, D0, data bucket 210. As previously discussed, in an embodiment for CAT problems, each database token string 205 can be a word or a phrase or a sentence or a paragraph or a chapter, etc.

In an embodiment each database token string 205 of the D0 data bucket 210 points to, or otherwise references, its solution data 220. For the embodiment database 200 for use in CAT the solution data 220 for a database token string 205 is the database token string's translation.

In alternative embodiments a representation of the tokens of a database token string 205, such as, but not limited to, numbers representing tokens, symbols representing tokens, a hash representation of each database token string, etc., are stored in the D0 data bucket 210.

In alternative embodiments a representation of the solution data 220, such as, but not limited to, one or more numbers, one or more symbols, a hash representation, for each solution data, etc., is referenced by the respective database token string 205.

In other embodiments for other problem types, such as, but not limited to, street address identification, common typographical error identification, DNA sequencing identification, fingerprint identification, or face recognition, the original database token strings stored, or otherwise identified, in the D0 data bucket 210 point to, or otherwise reference, their associated solution data. For example, in an alternative embodiment for computer aided fingerprint identification, the database token strings stored in the D0 data bucket contain, or otherwise identify, data sufficient to define a person's fingerprint(s). In this exemplary alternative embodiment each database token string of the D0 data bucket points to, or otherwise references, the identity of the person with the matching fingerprint(s).

In an embodiment for computer aided translation (CAT) problems, one token at a time is removed from each database token string 205 and the resulting similar database token string, or a representation thereof, 235 is stored in a second, D1, data bucket 230. Referring again to FIG. 1, similar token string 115 with the one token “red” word removed from the original database token string 100 is stored in a second, D1, data bucket 230. Similar token strings 235 stored in the D1 data bucket 230 represent a distance of one from the database token string 205 from which they are generated as they each contain one less token than the database token string 205 that they are generated from.

In an embodiment each similar token string 235 of the D1 data bucket 230 points to, or otherwise references, the database token string 205 from which it was generated. In this embodiment for example, similar token string 115 of FIG. 1, stored in the D1 data bucket 230, points to, or otherwise references, the database token string 100 stored in the D0 data bucket 210. In an alternate embodiment each similar token string 235 of the D1 data bucket 230 points to, or otherwise references, the solution data 220, e.g., translation, for the database token string 205 from which it was derived. In this alternative embodiment for example, similar token string 115 of FIG. 1 points to, or otherwise references, the translation 220 for the database token string 100.

In an embodiment for CAT problems combinations of two tokens at a time are removed from each database token string 205 and the resulting similar database token string, or a representation thereof, 245 is stored in a third, D2, data bucket 240. Referring again to FIG. 1, similar database token string 130, with the combination of two tokens, in this case words “red” and “is,” removed from the database token string 100 is stored in a D2 data bucket 240. Similar database token strings 245 stored in the D2 data bucket 240 are a distance of two from the database token string 205 from which they are generated as they each contain two less tokens than their corresponding database token string 205.

In an embodiment each similar token string 245 of the D2 data bucket 240 points to, or otherwise references, the database token string 205 from which it was derived. In this embodiment for example, similar token string 130 of FIG. 1, stored in the D2 data bucket 240, points to, or otherwise references, the database token string 100 stored in the D0 data bucket 210. In an alternate embodiment each similar token string 245 in the D2 data bucket 240 points to, or otherwise references, the solution data 220, e.g., translation, for the database token string 205 from which it was derived. In this alternative embodiment for example, similar token string 130 of FIG. 1 points to, or otherwise references, the translation 220 for the database token string 100.

In an embodiment for CAT problems combinations of three tokens at a time are removed from each database token string 205 and the resulting similar token string, or a representation thereof, 255 is stored in a fourth, D3, data bucket 250. Referring to FIG. 1, similar token string 185, with a combination of three tokens, in this case, words, “red,” “is” and “the,” removed from the original database token string 100 is stored, or otherwise referenced, in a fourth, D3, data bucket 250. Similar token strings 255 stored in the D3 data bucket 250 are a distance of three from the database token string 205 from which they are generated as they each contain three less tokens than the database token string 205 from which they are generated.

In an embodiment each similar token string 255 of the D3 data bucket 250 points to, or otherwise references, the database token string 205 from which it was derived. In this embodiment for example, similar token string 185 of FIG. 1, stored in the D3 data bucket 250, points to, or otherwise references, the database token string 100 stored in the D0 data bucket 210. In an alternate embodiment each similar token string 255 in the D3 data bucket 250 points to, or otherwise references, the solution data 220, e.g., translation, for the database token string 205 from which it was derived. In this alternative embodiment for example, similar token string 185 of FIG. 1 points to, or otherwise references, the translation 220 for the database token string 100.

In some embodiments combinations of four, five, etc. tokens at a time are removed from each database token string 205 and the resulting similar token strings, or representations thereof, are stored, respectively, in a fifth, D4, sixth, D5, seventh, D6, etc. data bucket. Similar token strings stored in a D4 data bucket represent a distance of four from the database token string 205 from which they are generated as they each contain four less tokens than the database token string 205 from which they are generated. Likewise, similar token strings stored in a D5 data bucket represent a distance of five from the database token string 205 from which they are generated as they each contain five less tokens, and so on.

In an embodiment each similar token string of the D4 data bucket, D5 data bucket, D6 data bucket, etc. points to, or otherwise references, the database token string 205 from which it was derived. In this embodiment for example, a similar token string stored in a D4, D5, D6, etc. data bucket points to, or otherwise references, the database token string 205 stored in the D0 data bucket 210 from which it was derived. In an alternate embodiment each similar token string in the D4, D5, D6, etc. data bucket points to, or otherwise references, the solution data 220, e.g., translation, for the database token string 205 from which it was derived. In this alternative embodiment for example, a similar token string stored in a D4, D5, D6, etc. data bucket points to, or otherwise references, the translation 220 for the database token string 205 from which it was generated.

In an embodiment the number of data buckets generated for a database 200 is determined by the maximum allowable, or acceptable, distance an input token string can be from an existing database token string 205 and the database token string 205 is still deemed an acceptable match. In an embodiment distance is measured in the number of different tokens between an input token string and a database token string stored in a first data bucket D0 210. In this embodiment a different token is an added token, a removed token, or a changed token.

For example, assume a maximum distance of one is set, or otherwise determined, for computer aided translations, i.e., the input token string to be translated can be no more than one added token, one removed token or one changed token from a database token string 205 stored in a D0 data bucket 210. In this example only a D0 data bucket 210 and a D1 data bucket 230 need be generated. No additional data bucket, e.g., D2 data bucket 240, D3 data bucket 250, etc., need be generated as any similar database token string of any of these data buckets, even if matched to an input token string, will be an unacceptable distance of at least two.

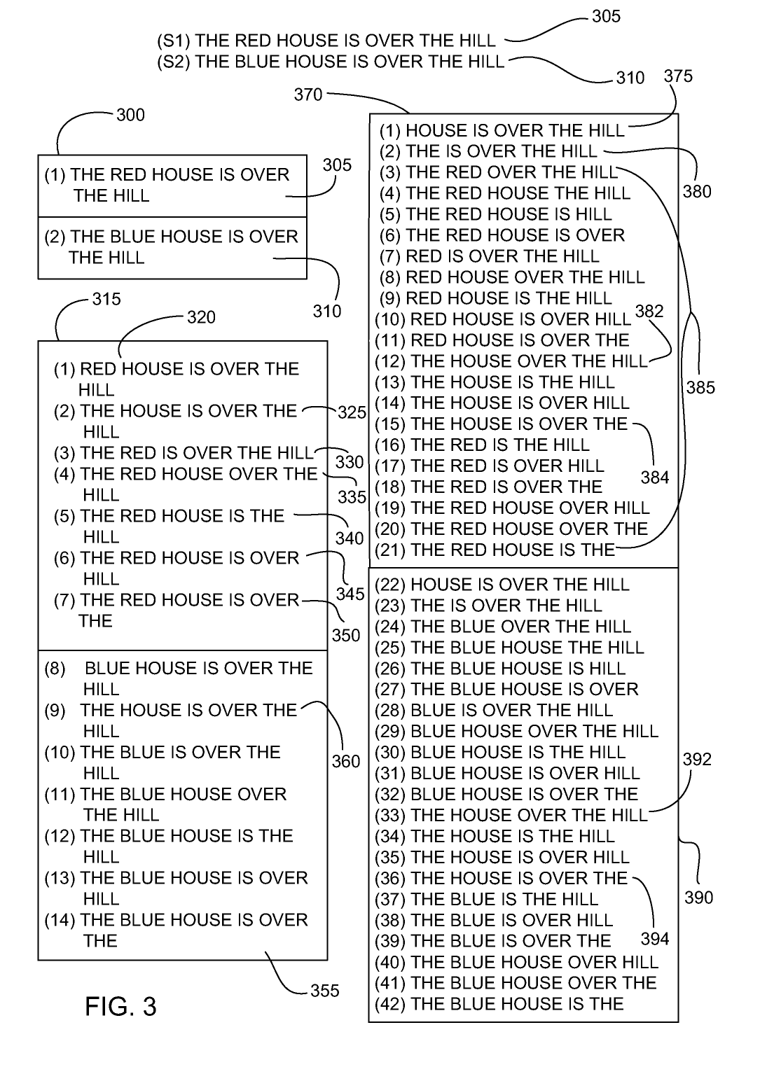

FIG. 3 is an example of two database token strings, in this case, sentences, S1 305 and S2 310, and their respective generated similar database token strings stored in a database in various data buckets, i.e., data bucket D0 300, data bucket D1 315 and data bucket D2 370. In the simplistic example, a first database sentence S1 305 is “The red house is over the hill”. A second database sentence S2 310 is “The blue house is over the hill”. Both database sentences S1 305 and S2 310 have corresponding data solutions, i.e., translations, stored in, or otherwise referenced by, the database.

In an embodiment each unaltered database token string that has a translation, or a representation thereof, is stored in a first data bucket D0 210. Thus, in the example of FIG. 3 the first database sentence S1 305, “The red house is over the hill,” is stored in a first data bucket D0 300. The second database sentence S2 310, “The blue house is over the hill,” is also stored in the first data bucket D0 300.

In an embodiment for CAT problems each database token string stored in the first data bucket D0 300 points to, or otherwise references, its translation.

As discussed, in an embodiment for CAT problems each token of each database token string is removed, one at a time, from the database token string and the resultant similar database token string, or a representation thereof, is stored in a second data bucket D1 230. In the example of FIG. 3, each token, i.e., word, of each database sentence S1 305 and S2 310 is removed, one at a time, from the respective database sentence and the resultant similar database token string, or a representation thereof, is stored in the D1 data bucket 315. For example, the first word “The” of the first database sentence S1 305 is removed resulting in the similar database sentence “red house is over the hill” 320 which is stored in the D1 data bucket 315. The second word “red” of the first database sentence S1 305 is removed resulting in the similar database sentence “The house is over the hill” 325 which is also stored in the D1 data bucket 315. Similarly, the remaining words of the first database sentence S1 305, i.e., “house,” “is,” “over,” “the,” and “hill,” are each removed, one at a time resulting in similar database sentences 330, 335, 340, 345 and 350 respectively, which are stored in the D1 data bucket 315.

In the example of FIG. 3 each token, i.e., word, of the second database token string S2 310 is also removed, one at a time and the resultant similar database token strings 355 are also stored in the D1 data bucket 315.

In an embodiment each similar database token string of the second data bucket D1 315 points to, or otherwise references, the database token string from which it was derived. For example, each of similar database sentences 320, 325, 330, 335, 340, 345 and 350 of the second data bucket D1 315 points to, or otherwise references, the database token string S1 305 from which they are all derived. Likewise, each of the group of similar database sentences 355 of the second data bucket D1 315 points to, or otherwise references, the database sentence S2 310 from which they are all derived.

In an alternate embodiment each similar database token string of the second data bucket D1 315 points to, or otherwise references, the solution data, i.e., translation, to be used for the database token string from which the similar database token string was derived.

As shown in the example of FIG. 3 the same similar database token string may exist for two, or more, database token strings. In FIG. 3, the similar database sentence “The house is over the hill” 325 generated from the database sentence S1 305 is the same similar database sentence 360 generated from the database sentence S2 310.

In an embodiment same similar database token strings are repeated in their respective data bucket, each referencing the database token string 205 from which they were generated, or, alternatively, the solution data 220 for the database token string 205 from which they were generated. Referring to FIG. 3, in this embodiment the similar database sentence 325 generated from the database sentence S1 305 is stored in the D1 data bucket 315 and points to, or is otherwise associated with, the database sentence S1 305, or, alternatively, the translation for S1 305. Likewise in this embodiment the similar database sentence 360 generated from the database sentence S2 310 is stored in the D1 data bucket 315 and points to, or is otherwise associated with, the database sentence S2 310, or, alternatively, the translation for S2 310.

In an alternate embodiment only one copy of a similar database token string is stored in a data bucket. In an aspect of this alternative embodiment the stored similar database token string points to, or otherwise references, each database token string 205 from which it was derived. In an alternate aspect of this alternative embodiment the stored similar database token string points to, or otherwise references, the solution data 220 for each database token string 205 from which it was derived. Thus, referring to FIG. 3, in this alternate embodiment only similar database sentence 325 or similar database sentence 360 is stored in the D1 data bucket 315. In an aspect of this alternative embodiment the one stored copy of the similar database sentence points to, or otherwise is associated with, both database sentences S1 305 and S2 310. In an alternative aspect of this alternative embodiment, the one stored copy of the similar database sentence points to, or otherwise is associated with, the solution data, i.e., translation, for each of the database sentences S1 305 and S2 310.

In an embodiment for CAT problems, if acceptable similarity is defined by a distance of two or less every combination of two tokens of each database token string is removed, one at a time, from the database token string and the resultant similar database token string, or a representation thereof, is stored in a third data bucket, D2, 370. In the example of FIG. 3 each combination of two tokens, i.e., words, of each database sentence S1 305 and S2 310 is removed, one at a time, and the resultant similar database token string, or a representation thereof, is stored in the D2 data bucket 370. For example, the combination of the first word “The” and second word “red” of the first database sentence S1 305 is removed resulting in the similar database sentence “house is over the hill” 375, which is stored in the D2 data bucket 370. The combination of the second word “red” and third word “house” of the S1 305 database sentence is removed resulting in the similar database sentence “The is over the hill” 380 which is also stored in the D2 data bucket 370. Similarly, the remaining combinations of two words of the S1 305 database sentence, e.g., “house” and “is,” “is” and “over,” etc., are each removed resulting in the similar database sentences 385 of the D2 data bucket 370.

In the example of FIG. 3 each combination of two words of the second database sentence S2 310 are also removed, one at a time, from the database sentence S2 310 and the resultant similar database sentences 390 are stored in the D2 data bucket 370.

In an embodiment each similar database token string of the D2 data bucket 370 points to, or otherwise references, the database token string from which it was derived. For example, each of similar database sentences 375 and 380 and the group of similar database sentences 385 of the D2 data bucket 370 points to, or otherwise references, the database sentence S1 305 from which they are all derived. Likewise, each of the group of similar database sentences 390 of the D2 data bucket 370 points to, or otherwise references, the database sentence S2 310 from which they are all derived.

In an alternate embodiment each similar database token string of the D2 data bucket 370 points to, or otherwise references, the solution data, e.g., translation, for the database token string from which the similar database token string was derived.

In an embodiment for CAT problems, if acceptable similarity is defined by a distance of three or less every combination of three tokens of each database token string is removed, one at a time, from the database token string and the resultant similar database sentences, or representations thereof, are stored in a fourth data bucket, not shown. Likewise, if acceptable similarity is defined by a distance of four or less every combination of four tokens of each database token string is removed, one at a time, from the database token string and the resultant similar database token strings, or representations thereof, are stored in a fifth data bucket, also not shown, and so on, for distances of five, six, etc.

In an embodiment, as with data buckets D1 315 and D2 370, each similar database token string of any data bucket points to, or otherwise references, the database token string from which it was derived. In an alternate embodiment each similar database token string of any data bucket points to, or otherwise references, the solution data for the database token string from which it was generated.

Once currently existing database token strings are processed and the database token strings and any derived similar database token strings are established in a database CAT can be performed.

In an embodiment similar database token strings need only be derived by the removal of one or more tokens from the original database token strings. In this embodiment no additions or changes are necessary to the original database token strings for the database to be effective for exact and similar matching. In this embodiment, because changes and/or alterations to an input token string can be removed to create one or more similar input token strings to be compared to the database, the database need only include strings resultant from token removals to supply the necessary similar database token strings for potential matching.

For example, an input token string “The big red house is beyond the hill” to be translated has one additional word, “big,” and one changed word, “beyond” for “over,” from the database sentence S1 305 “The red house is over the hill” of FIG. 3. By removing two words, “big” and “beyond,” from the input string a match is found to the similar database token string “The red house is the hill” 340. This example shows that even though the input token string had an added token and a changed token from any database token string, a match could be made in the database to a similar database token string derived from removing a token. Thus, there is no need to generate any similar database token strings by adding or changing any tokens to create a search space, i.e., database, sufficient for matching.

In an embodiment a match for an input token string to be translated is searched for in one or more database data buckets.

In an embodiment database searches for at least one match for an input token string are performed simultaneously in the existing data buckets. In an aspect of this embodiment database searches of each data bucket are performed for a preset time. In another aspect of this embodiment database searches of each data bucket are performed until a match is found in any one data bucket or all data buckets are searched with no matches being identified. In yet another aspect of this embodiment database searches of each data bucket are performed for a preset time or until a predetermined number of matches are identified in one or more data buckets.

In an alternate embodiment data buckets are searched in a predefined order for at least one match for an input token string. In an aspect of this alternative embodiment the D0 data bucket, containing unaltered database token strings, is searched first for one or more matches to the input token string. The D1 data bucket, containing similar database token strings with a distance of one from the database token strings, is then searched for one or more matches to the input token string. Next, the D2 data bucket, containing similar database token strings with a distance of two from the database token strings, if it exists, is searched for one or more matches to the input token string. Thereafter, the D3 data bucket, if it exists, is searched, and so on, with, if they exist, the D4, D5, etc. data buckets.

In an aspect of this alternative embodiment a database search of one or more of the data buckets is performed for a preset time. In another aspect of this alternative embodiment a search of one or more of the data buckets is performed until a match is found or all the existing data buckets are searched with no matches being identified. In yet another aspect of this alternative embodiment a search of one or more of the data buckets is performed for a preset time or until a predetermined number of matches is identified in one or more data buckets.

In an embodiment, if only one match is found in the database for the current input token string and the match is of the D0 data bucket, the solution data, e.g., translation, associated with the match database token string is used for the input token string. In this embodiment, if only one match is found in the database for the current input token string and the match is a similar database token string, the solution data associated with the database token string from which the match similar database token string was derived is used for the input token string.

In an embodiment, if more than one match is identified in the database for an input token string and two or more of the matches are identified with differing solution data, e.g., translations, post processing is preformed to identify a solution data to be used for the input token string. In one aspect of this embodiment post processing involves ranking solution data based on frequency of use. In this aspect of this embodiment for CAT problems, the solution data, i.e., translation, associated with a match token string of a data bucket that is ranked as most frequently used among the potential translations for an input token string is used as the translation for the input token string. In other aspects and/or other problem types, e.g., DNA sequencing identification, fingerprint identification, etc., other and/or additional criteria is used to identify a solution data among two or more potential solution data for an input token string.

In an alternative embodiment, if more than one match is identified in the database for an input token string and two or more of the matches are identified with differing solution data, e.g., translations, each match in the database for the input token string is provided to a user and the user is directed to choose one. In this embodiment, if the user chosen match is a database token string, its associated solution data, e.g., translation, is used for the input token string. In this embodiment, if the user chosen match is a similar database token string the solution data, e.g., translation, associated with the database token string from which the user chosen similar database token string was derived is used for the input token string.

In a second alternate embodiment, if more than one match is identified for an input token string and two or more matches are identified with differing solution data, e.g., translations, the solution data for each matching database token string and the solution data for each database token string from which any matching similar database token string was derived are provided to the user and the user is directed to choose one. In this second alternative embodiment, the user chosen solution data, e.g., translation, is used for the input token string.

In an embodiment, if no match is found in the database for a current input token string, a token, e.g., word, sentence, etc., of the input token string is removed and the resultant revised similar input token string is compared against the database token strings and similar database token strings of one or more data buckets as described above with reference to the original, unaltered, input token string. If one match is found in a data bucket for the similar input token string embodiment processing is performed as previously described with reference to a single match identified in the database for the original input token string. If more than one match is found in one or more data buckets for the similar input token string embodiment processing is performed as previously described with reference to multiple matches identified in the database for the original input token string.

In this embodiment, if no match is found for the revised similar input token string, a different token of the input token string is removed and the new resultant revised similar input token string is compared against the database token strings and similar database token strings of one or more data buckets as previously described with reference to the original input token string. Again, if a match is found in a data bucket for the newly revised input token string the data solution, e.g., translation, identified with the database match token string can be used for the input token string. If one match is found in a data bucket for this second similar input token string embodiment processing is performed as previously described with reference to a single match identified in the database for the original input token string. If more than one match is found in one or more data buckets for this second similar input token string embodiment processing is performed as previously described with reference to multiple matches identified in the database for the original input token string.

In this embodiment, if no match is found for the second revised input token string, different tokens of the input token string continue to be removed, one at a time, and the resultant revised input token strings are compared against the database token strings and similar database token strings of one or more data buckets until a match is found or no match is found for any revised input token string.

In an embodiment, if no match is found in the database for any derived similar input token string resulting from the removal of one token from the original input token string and the acceptable solution data distance is one, the database search is ended and no solution, e.g., translation, is provided for the current input token string.

In an embodiment, if no match is found in the database for any derived similar input token string resulting from the removal of one token from the input token string but the acceptable solution data distance is two, a combination of two tokens from the input token string is removed, and the resultant revised similar input token string is compared against the database token strings and similar database token strings of one or more data buckets. If one match is found in a data bucket for this new similar input token string embodiment processing is performed as previously described with reference to a single match identified in the database for the original input token string. If more than one match is found in one or more data buckets for this new similar input token string embodiment processing is performed as previously described with reference to multiple matches identified in the database for the original input token string.

In this embodiment, if no match is found for the similar input token string derived from removing two tokens from the input token string, different combinations of two tokens of the original input token string continue to be removed with the resultant revised similar input token strings compared against the database token strings and similar database token strings of one or more data buckets until a match is found or no match is found.

In an embodiment, if no match is found in the database for any similar input token string derived from removing a combination of two tokens from the original input token string and the acceptable solution data distance allowed is two, the database search is ended and no solution, e.g., translation, is provided for the current input token string.

In an embodiment, if no match is found in the database for any revised similar input token string resulting from the removal of a combination of two tokens, e.g., words, sentences, etc., from an original input token string but the allowed solution data, or search, distance is at least three then a combination of three tokens from the input token string is removed, and the resultant similar input token string is compared against the database token strings and similar database token strings stored in the various database data buckets. In this embodiment, if a match token string is found in a data bucket for the revised similar input token string the solution data, e.g., translation, identified with the match database token string or similar database token string is used for the input token string. In this embodiment, if no match is found for the revised similar input token string, different combinations of three tokens, e.g., words, of the original input token string continue to be removed with the resultant revised similar input token strings compared against the token strings of the database data buckets until a match is found or no match is found for any revised similar input token string.

In an embodiment the process continues until a match is found in the database for a derived similar input token string within the acceptable solution data, or search, distance. In an embodiment the process also continues until all token combinations for all acceptable search distances, e.g., four, five, etc., are removed from the input token string and no match is found in any data bucket for any derived similar input token string. In an embodiment processing can continue until one or more matches for an input token string or derived similar input token string are found in one or more data buckets or a predetermined time limit expires.

In an alternate embodiment similar input token strings with the same search distance, e.g., one, two, etc., are derived simultaneously and all such similar input token strings are compared simultaneously to the database token strings and similar database token strings of one or more data buckets. In a second alternative embodiment all similar input token strings of any acceptable search distance are derived simultaneously and the original input token string and all derived similar input token strings are compared simultaneously to the database token strings and similar database token strings of one or more data buckets.

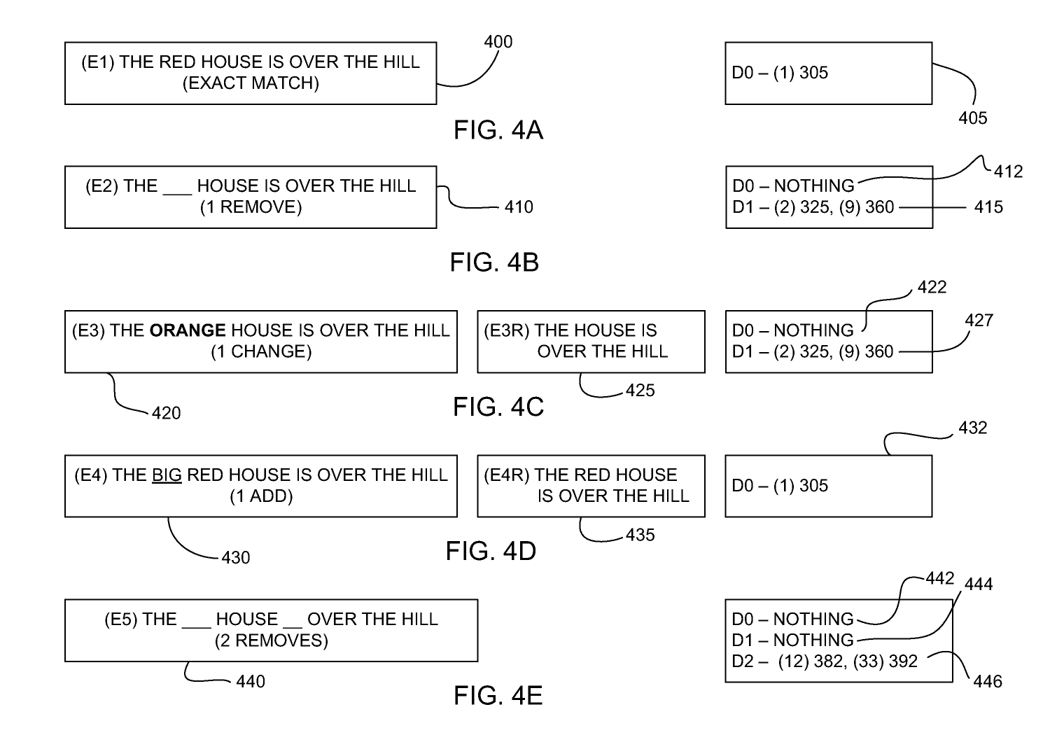

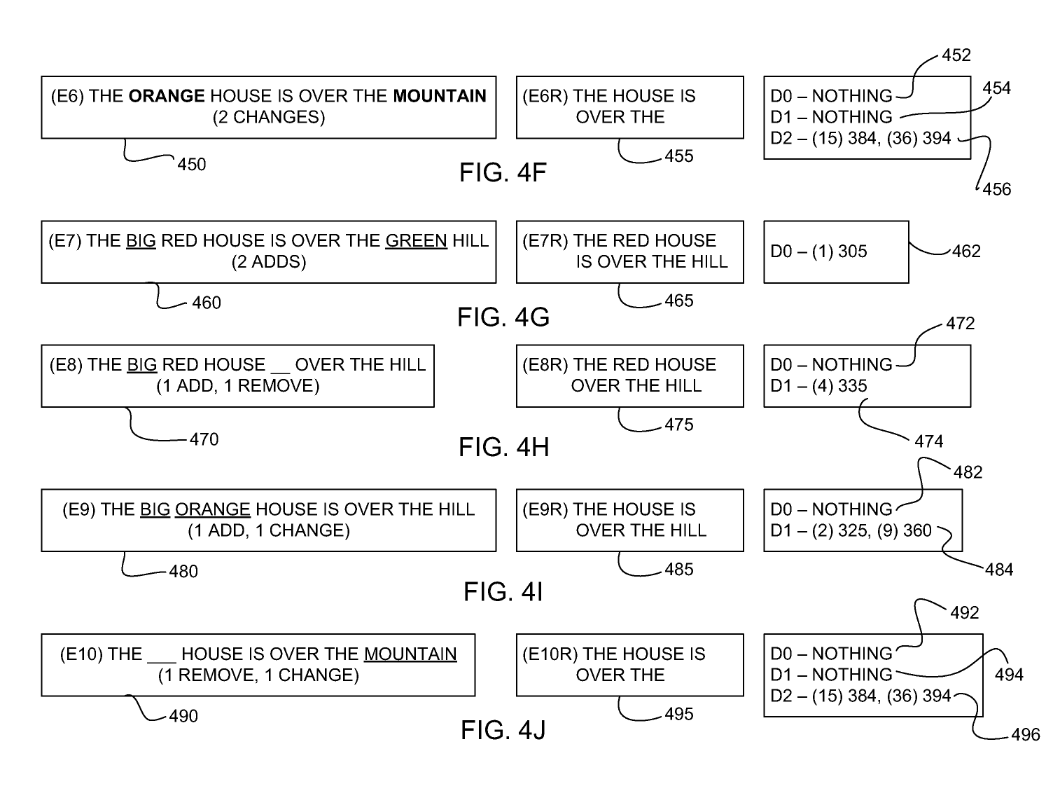

FIGS. 4A through 4J depict examples of input token strings of single sentences for computer aided translation. For purposes of explanation the input sentences of FIGS. 4A-4J are compared herein against the exemplary database of FIG. 3.

Referring to FIG. 4A, an exemplary input sentence E1 400, “The red house is over the hill,” is compared against the database token strings of the D0 data bucket 300 and the similar database token strings of the D1 315 and D2 370 data buckets of FIG. 3. In this example input sentence E1 400 is an exact match 405 to database sentence S1 305 of the D0 data bucket 300. Thus, in an embodiment, in this example the solution data, i.e., translation, for the database sentence S1 305 is used for the input sentence E1 400.

Referring to FIG. 4B, exemplary input sentence E2 410, “The house is over the hill,” is compared against the database token strings of the D0 300 data bucket and the similar database token strings of the D1 315 and D2 370 data buckets of FIG. 3. Input sentence E2 410 is not an exact match 412 to either of the two database sentences S1 305 and S2 310 of the D0 data bucket 300. Input sentence E2 410 is a match 415 to the similar database sentence 325 of the D1 data bucket 315. Input sentence E2 410 is also a match 415 to the similar database sentence 360 also of the D1 data bucket 315.

In the example of FIG. 4B more than one match token string exists in a data bucket for the input sentence and each of the match sentences are associated with differing translations. In this example the match similar database sentence 425 is associated with S1 305, “The red house is over the hill,” and its respective translation. The match similar database sentence 460 is associated with S2 310, “The blue house is over the hill,” and its respective translation.

In an embodiment post processing is performed to identify the translation for the input sentence E2 410 from the translations associated with the database sentences S1 305 and S2 310 from which the identified match similar database sentences 325 and 360 were generated.

In an alternate embodiment the two database sentences S1 305 and S2 310 associated with the match similar database sentences 325 and 360 respectively are presented to a user and the user is directed to choose either S1 305 or S2 310 to use for the translation of the input sentence E2 410. After the user chooses, the translation associated with the chosen database sentence S1 305 or S2 310 is used for the input sentence E2 410.

In yet another alternate embodiment the translations associated with the two database sentences S1 305 and S2 310 from which the match similar database sentences 325 and 360 respectively were derived are presented to the user. The user is directed to choose one of the translations to use for the input sentence E2 410. The user's choice is used for the translation for the input sentence E2 410.

With reference to FIG. 4C, exemplary input sentence E3 420, “The big house is over the hill,” is compared against the database sentences of the D0 data bucket 300 and the similar database sentences of the D1 315 and D2 370 data buckets of FIG. 3. Input sentence E3 420 is not an exact match 422 to either of the two database sentences S1 305 and S2 310 of the D0 data bucket 300. There is also no match in the other existing data buckets D1 315 and D2 370 for the input sentence E3 420.

If, however, one word, “big,” is removed from the input sentence E3 420, the resulting similar input sentence E3R 425, “The house is over the hill,” is a match 427 to the similar database sentence 325 of the D1 data bucket 315. The similar input sentence E3R 425 is also a match 427 to the similar database sentence 360 of the D1 data bucket 315.

In the example of FIG. 4C more than one match sentence exists for the similar input sentence E3R 425 and each of the match sentences is associated with a differing translation. In this example the match similar database sentence 325 is associated with the database sentence S1 305 and its respective translation. The match similar database sentence 360 is associated with the database sentence S2 310 and its respective translation.

In an embodiment post processing is performed to identify the translation for the input sentence E3 420 from the translations associated with the database sentences S1 305 and S2 310 from which the identified match similar database sentences 325 and 360 were generated.

In an alternate embodiment the two database sentences S1 305 and S2 310 associated with the match similar database sentences 325 and 360 respectively are presented to a user and the user is directed to choose either S1 305 or S2 310 to use for the translation of the input sentence E3 420. After the user chooses, the translation associated with the chosen database sentence S1 305 or S2 310 is used for the input sentence E3 420.

In yet another alternate embodiment the translations associated with the two database sentences S1 305 and S2 310 from which the match similar database sentences 325 and 360 respectively were derived are presented to the user. The user is directed to choose one of the translations to use for the input sentence E3 420. The user's choice is used for translation for the input sentence E3 420.

Referring to FIG. 4D, exemplary input sentence E4 430, “The big red house is over the hill,” is compared against the database sentences of the D0 data bucket 300 and the similar database sentences of the D1 315 and D2 370 data buckets of FIG. 3. Input sentence E4 430 is not an exact match to either of the two database sentences S1 305 and S2 310 of the D0 data bucket 300. There is also no match for the input sentence E4 430 in the other existing data buckets D1 315 and D2 370.

If, however, one word, “big,” is removed from the input sentence E4 430, the resulting similar input sentence E4R 435, “The red house is over the hill,” is a match 332 to the database sentence S1 305 of the D0 data bucket 300. Thus, in an embodiment, in this example the translation for the database sentence S1 305 is used for the input sentence E4 430.

Referring to FIG. 4E, exemplary search sentence E5 440, “The house over the hill,” is compared against the database sentences of the D0 data bucket 300 and the similar database sentences of the D1 315 and D2 370 data buckets of FIG. 3. Input sentence E5 440 is not an exact match 442 to either of the two database sentences S1 305 and S2 310 of the D0 data bucket 300. There is also no match 444 for the input sentence E5 440 in the other existing data buckets D1 315 and D2 370.

Input sentence E5 440 is, however, a match 446 to the similar database sentence 382 of the D2 data bucket 370. Input sentence E5 440 is also a match 446 to the similar database sentence 392 of the D2 data bucket 370. The match similar database sentences 382 and 392 of the D2 data bucket 370 represent a distance of two from their corresponding database sentences S1 305 and S2 310 respectively, for which translations exist. In this example the translations that could be used for the input sentence E5 440 are a distance of two from the input sentence E5 440. This is because there are two additional words in each of the database sentences S1 305, i.e., “red” and “is,” and S2 310, i.e., “blue” and “is,” associated with the potential translations to be used then exist in the input sentence E5 440.

If a search distance of two is unacceptable no translation can be generated for input sentence E5 440 with the exemplary database of FIG. 3. If, however, a search distance of two is acceptable then the matches 446 can be used to provide a translation for input sentence E5 440.

In the example of FIG. 4E more than one match database sentence exists for input sentence E5 440 and each of the match database sentences is associated with differing translations. In this example the match similar database sentence 382 is associated with S1 305 and its respective translation. The match similar database sentence 392 is associated with S2 310 and its respective translation.

In an embodiment post processing is performed to identify the translation for the input sentence E5 440 from the translations associated with the database sentences S1 305 and S2 310 from which the identified match similar database sentences 382 and 392 were generated.

In an alternate embodiment the two database sentences S1 305 and S2 310 associated with the match similar database sentences 382 and 392 respectively are presented to a user and the user is directed to choose either S1 305 or S2 310 to use for the translation of the input sentence E5 440. After the user chooses, the translation associated with the chosen database sentence S1 305 or S2 310 is then used for the input sentence E5 440.

In yet another alternate embodiment the translations associated with the two database sentences S1 305 and S2 310 from which the match similar database sentences 382 and 392 respectively were derived are presented to the user. The user is directed to choose one of the translations to use for the input sentence E5 440. The user's choice is then used as the translation for the input sentence E5 440.

In FIG. 4F, exemplary search sentence E6 450, “The orange house is over the mountain,” is compared against the database sentences of the D0 data bucket 300 and the similar database sentences of the D1 315 and D2 370 data buckets of FIG. 3. Input sentence E6 450 is not an exact match 452 to either of the two database sentences S1 305 and S2 310 of the D0 data bucket 300. There is also no match for the input sentence E6 450 in the other data buckets D1 315 or D2 370.

If any one word, e.g., “The,” “orange,” etc., is removed from input sentence E6 450, there is still no match 452 for the resulting revised input sentences in the D0 data bucket 300 nor any match 454 in the D1 data bucket 315. There is also no match for the resulting revised input sentences in the D2 data bucket 370.

If, however, a combination of two words is removed from input sentence E6 450, i.e., “orange” and “mountain,” the resulting similar input sentence E6R 455, “The house is over the,” is a match 456 to the similar database sentences 384 and 394 of the D2 data bucket 370. The match similar database sentences 384 and 394 of the D2 data bucket 370 represent a distance of two from their corresponding database sentences S1 305 and S2 310 respectively, for which translations exist. Thus, in this example the translations that could be used for the input sentence E6 450 are a distance of two from the input sentence E6 450. This is because there are two different words in each of the database sentences S1 305, i.e., “red” rather than “orange” and “hill” rather than “mountain,” and S2 310, i.e., “blue” rather than “orange” and “hill” rather than “mountain,” associated with the potential translations to be used.

If a search distance of two is unacceptable no translation can be generated for input sentence E6 450 with the exemplary database of FIG. 3. If, however, a search distance of two is acceptable then the matches 456 can be used to provide a translation for input sentence E6 450.

In the example of FIG. 4F more than one match similar database sentence exists for the input sentence E6 450, “The orange house is over the mountain,” and each of the match similar database sentences is associated with differing translations. In this example the match similar database sentence 384 is associated with S1 305 and its respective translation. The match similar database sentence 394 is associated with S2 310 and its respective translation.

In an embodiment post processing is performed to identify the translation for the input sentence E6 450 from the translations associated with the database sentences S1 305 and S2 310 from which the identified match similar database sentences 384 and 394 were generated.

In an alternate embodiment the two database sentences S1 305 and S2 310 associated with the match similar database sentences 384 and 394 respectively are presented to a user and the user is directed to choose either S1 305 or S2 310 to use for the translation of the input sentence E6 450. After the user chooses, the translation associated with the chosen database sentence S1 305 or S2 310 is then used for the input sentence E6 450.

In yet another alternate embodiment the translations associated with the two database sentences S1 305 and S2 310 from which the match similar database sentences 384 and 394 respectively were derived are presented to the user. The user is directed to choose one of the translations to use for the input sentence E6 450. The user's choice is then used as the translation for the input sentence E6 450.

Referring to FIG. 4G, exemplary input sentence E7 460, “The big red house is over the green hill,” is compared against the database sentences and similar database sentences of the data buckets of FIG. 3. Input sentence E7 460 is not an exact match to either of the two database sentences S1 305 and S2 310 of the D0 data bucket 300. There is also no match to the input sentence E7 460 in the D1 data bucket 315 or the D2 data bucket 370.

If any one word, e.g., “The,” “big,” etc., is removed from input sentence E7 460, there is still no match to the resulting similar input sentences in any of the data buckets D0 300, D1 315 or D2 370.

If, however, a combination of two words is removed from input sentence E7 460, i.e., “big” and “green” in this example, the resulting similar input sentence E7R 465, “The red house is over the hill,” is a match 462 to the database sentence 305 of the D0 data bucket 300. The similar input sentence E7R 465, however, is a distance of two from the database sentence S1 305 to which it matches and for which a translation exists. This is because there are two additional words in the original input sentence E7 460, i.e., “big” and “green,” then in the resulting similar input sentence E7R 465 which matches the database sentence S1 305. Thus, in this example, even though a match is found in the D0 data bucket 300 the match 462 is still a distance of two from the input sentence E7 460.

If a search distance of two is unacceptable no translation can be generated for input sentence E7 460 with the exemplary database of FIG. 3. If, however, a search distance of two is acceptable then the match 462 can be used to provide a translation for input sentence E7 460.

In the example of FIG. 4G as only one match, i.e., database sentence S1 305, exists for input sentence E7 460 the translation for the found match is used for input sentence E7 460.

In FIG. 4H exemplary input sentence E8 470, “The big red house over the hill,” is compared against the database sentences and similar database sentences of the D0 300, D1 315 and D2 370 data buckets of FIG. 3. Input sentence E8 470 is not a match 472 to either of database sentence S1 305 or S2 310 of the D0 data bucket 300. There is also no match for input sentence E8 470 in the D1 data bucket 315 or the D2 data bucket 370.

If one word, i.e., “big,” is removed from the input sentence E8 470 the resulting similar input sentence E8R 475, “The red house over the hill,” is a match 474 to the similar database sentence 335 of the D1 data bucket 315. The similar database sentence 335 is associated with database sentence S1 305 for which a translation exists.

The similar input sentence E8R 475, however, is a distance of two from S1 305 for which an existing translation can be used. This is because there is one added word, “big,” and one removed word, “is,” in input sentence E8 470 as compared to the database sentence S1 305. Thus, even though a match 474 for the E8 470 input sentence is found in the D1 data bucket 315, which includes similar database sentences that are a distance of one from the original database sentences for which translations exist, the match 474 represents a distance of two between the E8 470 input sentence and the database sentence S1 305.

If a search distance of two is unacceptable no translation can be generated for input sentence E8 470 with the exemplary database of FIG. 3. If, however, a search distance of two is acceptable then the match 474 can be used to provide a translation for input sentence E8 470.

In the example of FIG. 4H as only one match exists for input sentence E8 470 the translation for the found match, i.e., database sentence S1 305, is used.

In FIG. 4I exemplary input sentence E9 480, “The big orange house is over the hill,” is compared against the database sentences and similar database sentences of the D0 300, D1 315 and D2 370 data buckets of FIG. 3. Input sentence E9 480 has one additional word, i.e., “big,” than either database sentence S1 305 or database sentence S2 310, and one changed word, i.e., “orange” for “red” or “orange” for “blue,” from each of these respective database sentences 305 and 310. In this example input sentence E9 480 is not an exact match 482 to either of the two database sentences S1 305 and S2 310 of the exemplary database of FIG. 3. In this example there is also no match for input sentence E9 480 in the D1 315 or D2 370 data buckets.

If any one word, e.g., “The,” “big,” etc., is removed from input sentence E9 480, there is still no match to the resulting similar input sentences in any of the D0 300, D1 315 or D2 370 data buckets.

If, however, a combination of two words is removed from input sentence E9 480, i.e., “big” and “orange,” the resulting similar input sentence E9R 485, “The house is over the hill,” is a match 484 to each of the similar database sentences 325 and 360 of the D1 data bucket 315. The similar database sentence 325 is associated with S1 305 for which a translation exists. The similar database sentence 360 is associated with S2 310 for which a translation also exists.

The similar input sentence E9R 485, however, is a distance of two from the database sentences S1 305 and S2 310 for which existing translations can be used. This is because of the one added word, “big,” and one changed word, “orange” for “red,” in input sentence E9 480 as compared to the database sentence S1 305. Likewise, there is one added word, “big,” and one changed word, “orange” for “blue,” in input sentence E9 480 as compared to the database sentence S2 310. Thus, even though matches 484 are found in the D1 data bucket 315, which includes similar sentences with a distance of one from the original database sentences for which translations exist, the matches 484 represent a search distance of two for input sentence E9 480.

If a search distance of two is unacceptable no translation can be generated for input sentence E9 480 with the exemplary database of FIG. 3. If, however, a search distance of two is acceptable then the matches 484 can be used to provide a translation for input sentence E9 480.

As noted, in the example of FIG. 4I more than one match exists for the similar input sentence E9R 485, “The house is over the hill,” and each of the match database sentences is associated with differing translations.

In an embodiment post processing is performed to identify the translation for the input sentence E9 480 from the translations associated with the database sentences S1 305 and S2 310 from which the identified match similar database sentences 325 and 360 were generated.

In an alternate embodiment the two database sentences S1 305 and S2 310 associated with the match similar database sentences 325 and 360 respectively are presented to a user and the user is directed to choose either S1 305 or S2 310 to use for the translation of the input sentence E9 480. After the user chooses, the translation associated with the chosen database sentence S1 305 or S2 310 is then used for the input sentence E9 480.

In yet another alternate embodiment the translations associated with the two database sentences S1 305 and S2 310 from which the match similar database sentences 325 and 360 respectively were derived are presented to the user. The user is directed to choose one of the translations to use for the input sentence E9 480. The user's choice is then used for the translation for the input sentence E9 480.

With reference to FIG. 4J, exemplary input sentence E10 490, “The house is over the mountain,” is compared against the database sentences and similar database sentences of the D0 300, D1 315 and D2 370 data buckets of FIG. 3. Input sentence E10 490 has one removed word, i.e., “red” or “blue,” from database sentences S1 305 and S2 310 respectively. Input sentence E10 490 also has one changed word, i.e., “mountain” for “hill,” from each of S1 305 and S2 310. Input sentence E10 490 is not an exact match 492 to either of the two database sentences S1 305 and S2 310. There is no match 494 for input sentence E10 490 in the D1 data bucket 315. There is also no match for input sentence E10 490 in the D2 data bucket 370.

If one word, i.e., “mountain,” is removed from input sentence E10 490, the resulting similar input sentence E10R 495, “The house is over the,” is a match 496 to the similar database sentences 384 and 394 of the D2 data bucket 370. The similar database sentence 384 is associated with S1 305 for which a translation exists. The similar database similar sentence 394 is associated with S2 310 for which a translation also exists.

The similar input sentence E10R 495 is a distance of two from the database sentences S1 305 and S2 310 associated with the database matches 496. This is because there is one removed word, “red,” and one changed word, “mountain” for “hill,” in input sentence E10 490 as compared to the database sentence S1 305. Likewise, there is one removed word, “blue,” and one changed word, “mountain” for “hill,” in input sentence E10R 490 as compared to the database sentence S2 310. Thus, in this example matches 496 represent a search distance of two for the input sentence E10 490.

If a search distance of two is unacceptable no translation can be generated for input sentence E10 490 with the database of FIG. 3. If, however, a search distance of two is acceptable then the matches 496 can be used to provide a translation for input sentence E10 490.

As noted, in the example of FIG. 4J more than one match exists for the similar input sentence E10R 495, “The house is over the,” and each of the match database sentences is associated with differing translations.

In an embodiment post processing is performed to identify the translation for the input sentence E10 490 from the translations associated with the database sentences S1 305 and S2 310 from which the identified match similar database sentences 384 and 394 were generated.

In an alternate embodiment the two database sentences S1 305 and S2 310 associated with the match similar database sentences 384 and 394 respectively are presented to a user and the user is directed to choose either S1 305 or S2 310 to use for the translation of the input sentence E10 490. After the user chooses, the translation associated with the chosen database sentence S1 305 or S2 310 is then used for the input sentence E10 490.

In yet another alternate embodiment the translations associated with the two database sentences S1 305 and S2 310 from which the match similar database sentences 384 and 394 respectively were derived are presented to the user. The user is directed to choose one of the translations to use for the input sentence E10 490. The user's choice is then used for the translation for the input sentence E10 490.

Input token strings and/or database token strings can be very large, e.g., hundreds, and even thousands, of words for a translation problem, hundreds, and even thousands, of identifiers for DNA sequencing identification, etc. Thus, as previously described, a token can be any defined subset of a whole, e.g., but not limited to, for translation problems, a word and/or a phrase and/or a sentence and/or a paragraph and/or a chapter of two or more paragraphs, etc.

In embodiments an input token string and/or database token string(s) can be a collection of two or more token strings. For example, again with reference to translation problems, in an embodiment a first set of database tokens strings can have two or more strings of two or more words, e.g., a first set of database token strings can be two or more sentences. In this exemplary embodiment a second set of database token strings can be token strings that are a collection of two or more of the first set of database token strings, i.e., a second set of database token strings can have paragraphs of two or more of the sentences of the first set of database token strings.

In embodiments a database can have two or more sets of database token strings of different dimensions, where a dimension is a divisible unit of the data used for the particular problem for which the database is established to resolve. In other words, a larger dimension is a collection of tokens of a smaller dimension.

For example, in CAT problems input token strings may be paragraphs. Thus input token strings are collections of token strings, i.e., a paragraph token string is a collection of sentence token strings, and each sentence token string is a collection of word tokens. In this example the database can have two sets of database token strings of different dimensions: a first set of database token strings may be paragraphs and a second set of database token strings may be individual sentences of the paragraphs of the first set of database token strings.

Using the methodologies explained herein, similar database token strings of the first set of database token strings of paragraphs are derived by removing one sentence or a collection of two or more sentences from each database paragraph. Thus, for example, similar database token strings of the first set of database token strings with a distance of one are generated by removing each sentence, one at a time, from each database paragraph. Similar database token strings of the first set of database token strings with a distance of two are generated by removing each collection of two sentences from each database paragraph, and so on.

Similar database token strings of the second set of database token strings of sentences are derived by removing one word or a collection of two or more words from each sentence of each database paragraph of the first set of database token strings. Thus, for example, as previously described, similar database token strings of the second set of database token strings with a distance of one are generated by removing each word, one at a time, from each sentence of each database paragraph of the first set of database token strings. Similar database token strings of the second set of database token strings with a distance of two are generated by removing each collection of two words from each sentence of each database paragraph of the first set of database token strings, and so on.

Input token strings that are a paragraph are then compared to the first set of database token strings for a match. If no match is found, one or more similar input token strings are derived by removing one or a collection of two or more tokens, i.e., sentences, from the input token string. The derived similar input token string(s) are then compared to the first set of database token strings. If a match is found, granularity can be introduced into the problem solving mechanism for more accurate results. Thus, in the example of an input token string of a paragraph to be translated, granularity can be applied by generating a second set of similar input token string(s) of sentences by removing one or a combination of two or more words from the input token string sentences that were removed when a match in the first set of database token strings was discovered. The generated similar input token string sentence(s) are then compared to the second set of database token strings for a match, as previously described.

Using the methodology of dimensioning a database and the input token strings to be processed when input token strings can be expected to be generally large allows for a smaller search space, i.e., database, as well as for a more finely tuned, i.e., accurate, solution data. In embodiments dimensioning can be beyond two levels, e.g., sentences of paragraphs and words of sentences, based on input and/or search data characteristics, e.g., but not limited to, data size, inherent data dimensional levels, etc. In embodiments dimensioning can be beyond two levels based also, or alternatively, on programmed solution requirements, e.g., but not limited to, dimensional accuracy requirements, etc.

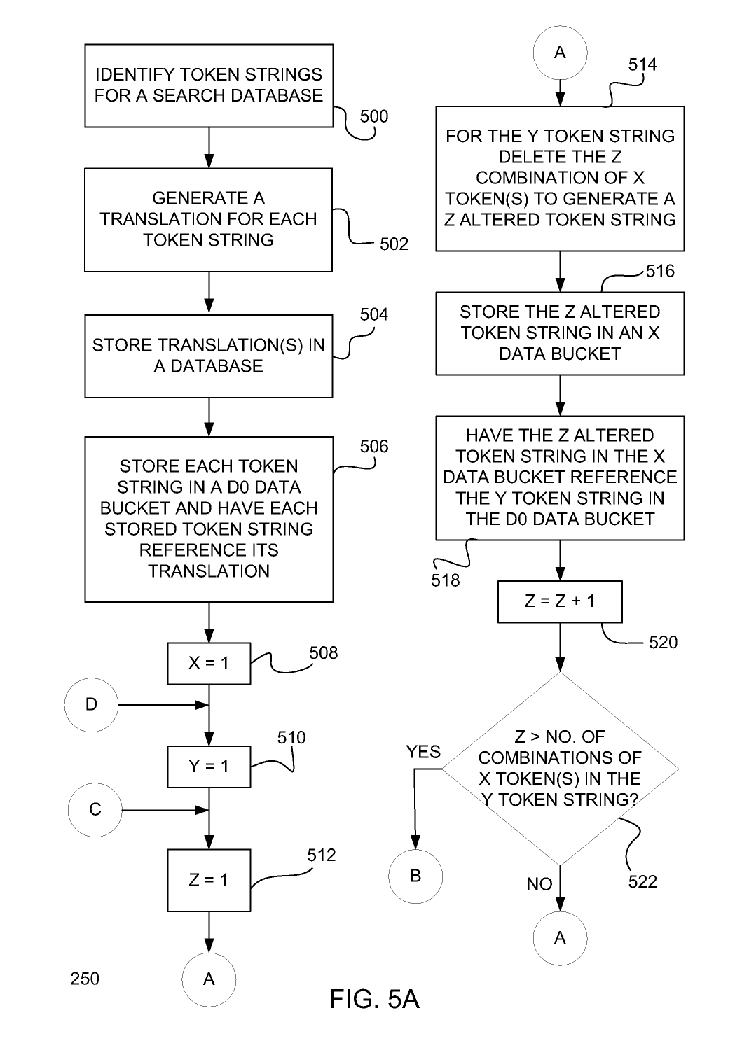

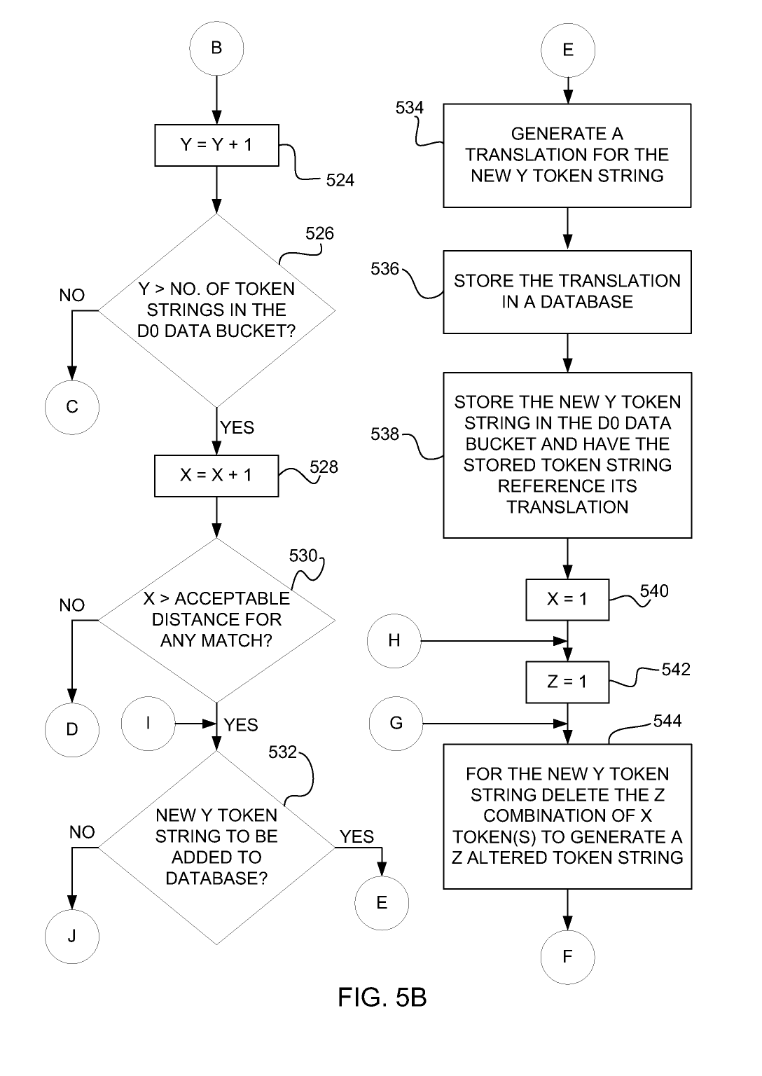

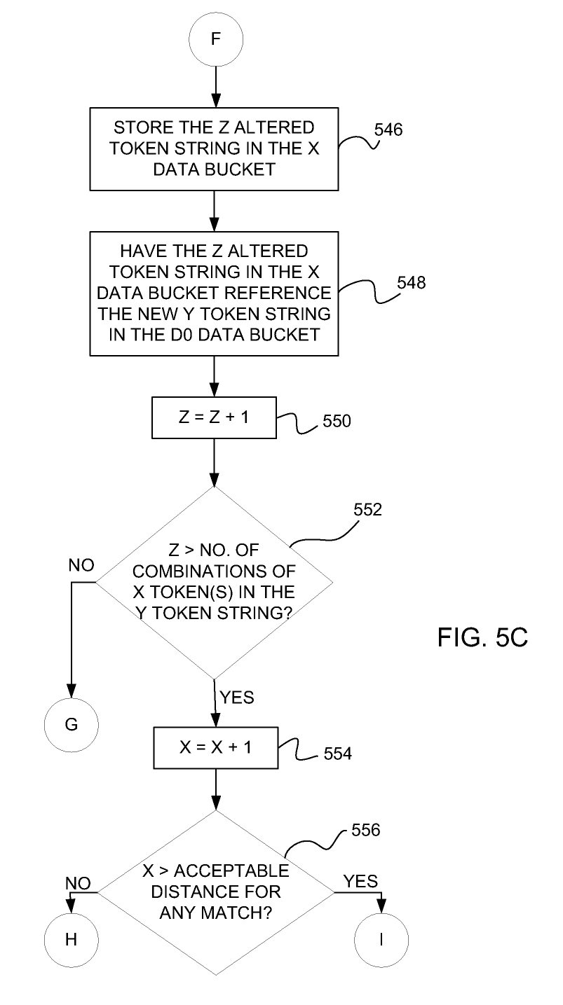

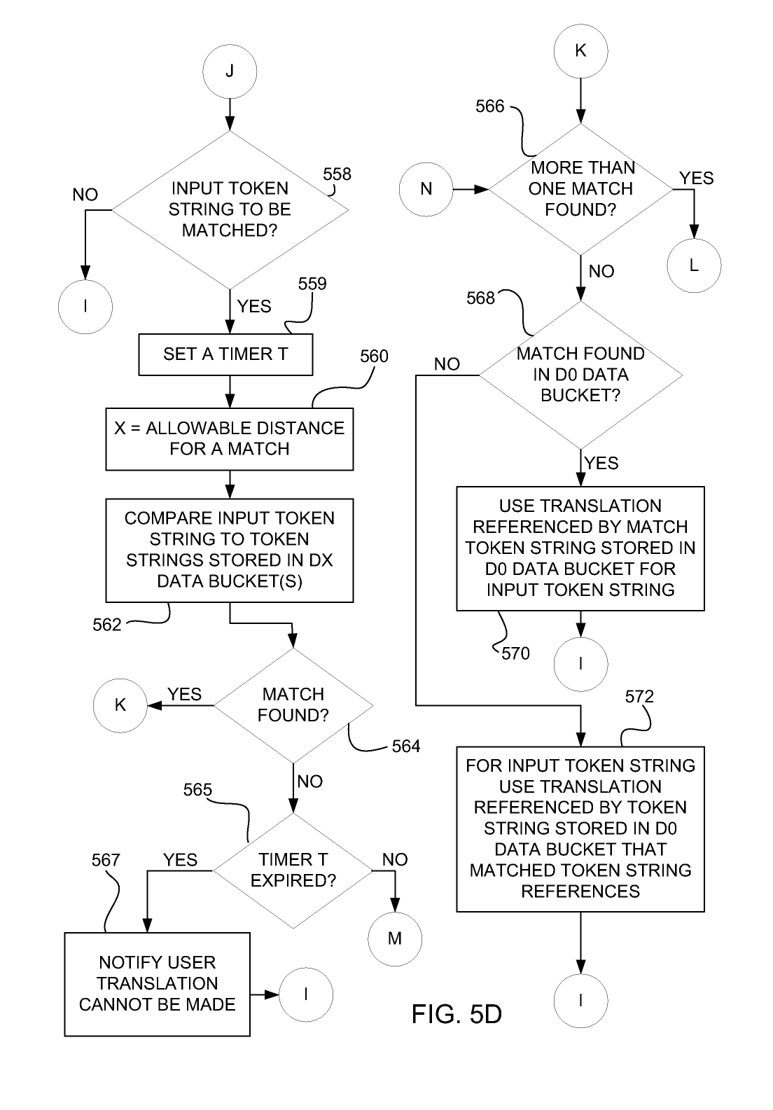

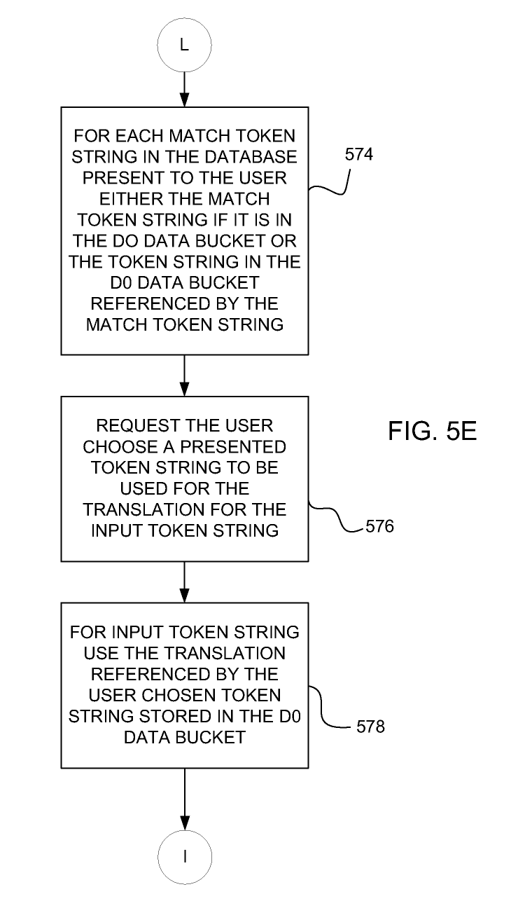

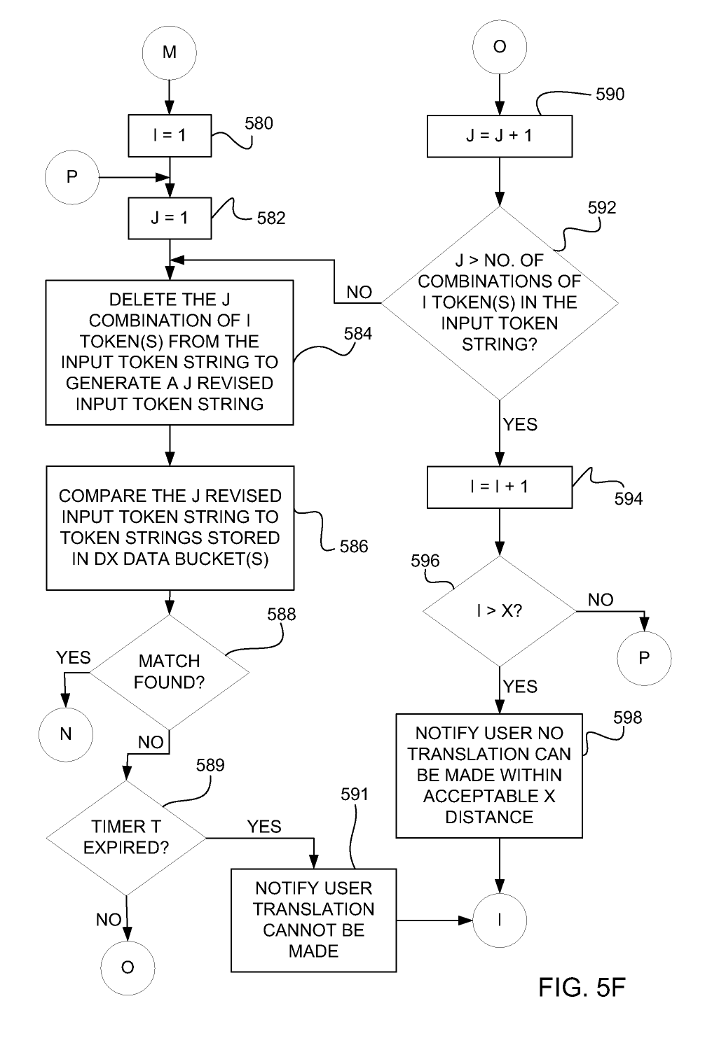

FIGS. 5A, 5B, 5C, 5D, 5E and 5F illustrate an embodiment logic flow for creating and using a search database for sub linear token string matching. While the following discussion is made with respect to systems portrayed herein, the operations described may be implemented in other systems. Further, the operations described herein are not limited to the order shown. Additionally, in other alternative embodiments more or fewer operations may be performed.

Referring to FIG. 5A, one or more token strings are identified to be used, or otherwise included, in a search database 500. In an embodiment solution data, e.g., a translation, is generated, or otherwise gathered or identified, for each database token string 502 and each solution data is stored in, or otherwise referenced by, the database 504. In other embodiments for processes other than CAT other solution data can be generated, or otherwise gathered, for the database token strings and stored in, or otherwise referenced by, the database, e.g., but not limited to, identities matched to fingerprint token string data, identities matched to face recognition token string data, etc.

In an embodiment each token string to be included in the database, or a representation thereof, is stored in, or otherwise referenced by, associated with or grouped together as, collectively referred to herein as stored in, a D0 data bucket 506. As previously discussed, in an embodiment a data bucket is a portion of a database that database token strings with the same distance are stored together in. In an embodiment each database token string stored in the D0 data bucket references its solution data, e.g., translation, 506.

In an embodiment processing loops are executed to generate similar database token strings from the original database token strings of the D0 data bucket. In an embodiment a first loop with an index, e.g., x, initialized to one (1) 508 is for generating a specific data bucket, e.g., D1, D2, etc., of similar database token strings. In an embodiment a second loop with an index, e.g., y, initialized to one (1) 510 is for processing each of the database token strings of the D0 data bucket, e.g., a first database token string of the D0 data bucket, a second database token

In an embodiment, for the current y database token string of the D0 data bucket the z^{th} combination of x token(s) is deleted, or otherwise removed or ignored, to derive a z^{th} similar database token string 514. In an embodiment the z^{th} similar database token string, or a representation thereof, is stored in the Dx data bucket 516. In an embodiment the z^{th} similar database token string of the Dx data bucket references the current y database token string of the D0 data bucket 518. In an alternate embodiment the z^{th} similar database token string of the Dx data bucket references the solution data, e.g., translation, of the current y database token string of the D0 data bucket.

For example, when x is equal to one, y is equal to one and z is equal to one, in an embodiment one first token of a first database token string of the D0 data bucket is deleted, or otherwise removed or ignored, to derive a first similar database token string that is, or a representation thereof is, stored in a D1 data bucket. In an embodiment the newly generated first similar database token string references the first database token string of the D0 data bucket. Referring to the exemplary database of FIG. 3, in this example a first combination of one token, e.g., the first “the” word, of the first database token string “The red house is over the hill” 305 of the D0 data bucket 300 is deleted, or otherwise removed or ignored, to generate a first similar database token string “red house is over the hill” 320 that is stored in the D1 data bucket 315. In an embodiment in this example the similar database token string 320 references the first database token string 305 of the D0 data bucket 300.

As another example, when x is equal to one, y is equal to one and z is equal to four, a fourth single token of a first database token string of the D0 data bucket is deleted, or otherwise removed or ignored, to derive a fourth similar database token string that is, or a representation thereof is, stored in a D1 data bucket. In an embodiment the newly generated fourth similar database token string references the first database token string of the D0 data bucket. Referring again to the exemplary database of FIG. 3, in this example a fourth combination of one token, e.g., the fourth “is” word, of the first database token string “The red house is over the hill” 305 of the D0 data bucket 300 is deleted, or otherwise removed or ignored, to generate a fourth similar database token string “The red house over the hill” 335 that is stored in the D1 data bucket 315. In an embodiment in this example the similar database token string 335 references the first database token string 305 of the D0 data bucket 300.

In an embodiment the third loop index, e.g., z, is incremented 520 so that the next combination of x number of tokens can be deleted, or otherwise removed or ignored, from the y database token string. At decision block 522 a determination is made as to whether or not the third index is now greater than the number of combinations of x token(s) in the current y database token string of the D0 data bucket. In other words, at decision block 522 a determination is made as to whether all combinations of the x number of tokens has been deleted, or otherwise removed or ignored, from the current y database token string to generate a similar database token string. If no, processing of the current y database token string continues with a new z^{th} combination of x number of token(s) being deleted, or otherwise removed or ignored, to derive a new z^{th} similar database token string 514.

If all combinations of the x number of tokens have been deleted, or otherwise removed or ignored, from the current y database token string, referring to FIG. 5B, in an embodiment the second loop index, e.g., y, is incremented 524 so that the next database token string of the D0 data bucket can be processed. At decision block 526 a determination is made as to whether or not the second index is now greater than the number of database token strings of the D0 data bucket. In other words, at decision block 526 a determination is made as to whether all the y database token strings of the D0 data bucket have had each combination of x number tokens deleted, or otherwise removed or ignored. If no, referring back to FIG. 5A, the third index, e.g., z, is reset to one 512 and processing of the new y database token string begins with the first combination of x number token(s) being deleted, or otherwise removed or ignored, to generate a first similar database token string for the new y database token string 514.

Referring again to FIG. 5B, if all y database token strings of the D0 data bucket have had each combination of x number of tokens deleted, or otherwise removed or ignored, in an embodiment the first loop index, e.g., x, is incremented 528 so that combinations of the new x number of tokens, e.g., two tokens, three tokens, etc., can be deleted, or otherwise removed or ignored, from each of the database token strings of the D0 data bucket. At decision block 530 a determination is made as to whether the first index is now greater than any acceptable search distance for a match using the search database. In other words, at decision block 530 a determination is made as to whether all the data buckets, e.g., D1, D2, etc., that are to be generated and used for any search match, have been generated. If no, referring back to FIG. 5A, the second index, e.g., y, is reset to one 510, the third index, e.g., z, is reset to one 512 and processing combinations of the new x number of tokens for each y database token string of the D0 data bucket to generate new similar database token strings begins 514.

Referring again to FIG. 5B, if all the data buckets to be generated have been generated then in an embodiment a search database is initially established with the database token strings currently identified for inclusion. At decision block 532 a determination is made as to whether a new y database token string is to be added to the search database.

If yes, in an embodiment solution data, e.g., a translation, is generated, or otherwise gathered or identified, for the new y database token string 534 and the solution data is stored in, or otherwise referenced by, the database 536. In an embodiment the new y database token string to be included in the database, or a representation thereof, is stored in the D0 data bucket 538. In an embodiment the new y database token string references its data solution, e.g., translation, 538.

In an embodiment processing loops are executed to generate similar database token strings for the new y database token string. In an embodiment a first loop with an index, e.g., x, initialized to one (1) 540 is for generating similar database sentences from the new y database token string for a specific, x, data bucket, e.g., D1, D2, etc. In an embodiment a second loop with an index, e.g., z, initialized to one (1) 542 is for deleting, or otherwise removing or ignoring, every combination of x number of token(s) from the new y database token string.

In an embodiment for the new y database token string, the z^{th} combination of x number of token(s) is deleted, or otherwise removed or ignored, to derive a z^{th} similar database token string 544. Referring to FIG. 5C, in an embodiment the z^{th} similar database token string is, or a representation thereof is, stored in the Dx data bucket 546. In an embodiment the z^{th} similar database token string of the Dx data bucket references the new y database token string of the D0 data bucket 548. In an alternate embodiment the z^{th} similar database token string of the Dx data bucket references the solution data, e.g., translation, for the new y database token string.

In an embodiment the second loop index, e.g., z, is incremented 550 so that the next combination of x number of tokens can be deleted, or otherwise removed or ignored, from the new y database token string. At decision block 552 a determination is made as to whether or not the second index is now greater than the number of combinations of x token(s) in the new y database token string. If no, referring again to FIG. 5B, processing of the new y database token string continues with the new z^{th} combination of x number of token(s) being deleted, or otherwise removed or ignored, to derive a new z^{th} similar database token string 514.

If all combinations of the x number of tokens have been deleted, or otherwise removed or ignored, from the new y database token string, referring to FIG. 5C, in an embodiment the first loop index, e.g., x, is incremented 554 so that combinations of the new x number of tokens, e.g., two tokens, three tokens, etc., can be deleted, or otherwise removed or ignored, from the new y database token string. At decision block 556 a determination is made as to whether the first index, i.e., x, is now greater than any acceptable search distance for the search database. In other words, at decision block 556 a determination is made as to whether all the similar database token strings that are to be generated from the new y database token string have been generated. If no, referring back to FIG. 5B, the second index, e.g., z, is reset to one 542 and processing of the new y database token string continues with the first combination of the new x number of token(s) being deleted, or otherwise removed or ignored, to generate a first similar database token string for the Dx data bucket from the new y database token string 544.

If all the similar database token strings to be generated for the new y database token string have been generated, referring to FIG. 5B, at decision block 532 a determination is made as to whether there is now a new database token string to be added to the search database.

If there is currently no new database token string to be added to the search database, referring to FIG. 5D, at decision block 558 a determination is made as to whether there is an input token string to be processed. If no, in an embodiment processing returns to decision block 532 of FIG. 5B, to determine if there is a new token string to be added to the search database.

If at decision block 558 of FIG. 5D there is currently an input token string to be processed, then in an embodiment a timer, e.g., t, is set or otherwise established 559. In this embodiment searches in the database for matches to the input token string will only be performed within the set timer period.

In an embodiment the allowable, or acceptable search distance, e.g., x, is set 560. The input token string is then compared to the database token strings in the D0 through Dx data bucket(s) 562. Thus, for example, if the acceptable search distance for a current input token string is two then in an embodiment the input token string will be compared to the database token strings of the D0 data bucket and the similar database token strings of the D1 and D2 data buckets 562. As another example, if the acceptable search distance for a current input token string is zero, meaning an exact match must exist, then in an embodiment the input token string will be compared to the database token strings of the D0 data bucket 562.

At decision block 564 a determination is made as to whether a match to the input token string was found in any of the searched data buckets. If yes, then at decision block 566 a determination is made as to whether more than one match to the input token string was found in one or more of the searched data buckets. If no, meaning only one match token string was found for the input token string, then at decision block 568 a determination is made as to whether the match token string in the database is in the D0 data bucket. If yes, in an embodiment the solution data, e.g., translation, referenced by the match database token string of the D0 data bucket is used, or otherwise provided, for the input token string 570.

At decision block 568 of FIG. 5D, if it is determined that the one match token string of the database is not in the D0 data bucket, then in an embodiment the solution data, e.g., translation, referenced by the database token string of the D0 data bucket that is, in turn, referenced by the match similar database token string is used, or otherwise provided, for the input token string 572.

Once solution data is identified for an input token string matched to a database token string or similar database token string, in an embodiment processing returns to FIG. 5B, where once again a determination is made as to whether there is currently a new database token string to be added to the database 532.

Referring back to decision block 566 of FIG. 5D, if there is more than one match token string in the database for the current input token string then, referring to FIG. 5E, in an embodiment each match database token string of the D0 data bucket is presented to the user 574. In an embodiment each database token string of the D0 data bucket that is referenced by a match similar database token string of a data bucket other than the D0 data bucket is presented to the user 574. In an embodiment the user is requested to choose a presented token string to be used for as the solution data, e.g., translation, for the input token string 576. In an embodiment upon receiving the user chosen database token string, the solution data referenced by this database token string is used, or otherwise provided, for the input token string 578. In an embodiment processing then returns to FIG. 5B, where once again a determination is made as to whether there is currently a new database token string to be added to the database 532.

In an alternate embodiment, if there is more than one match token string in the database for the current input token string then each solution data, e.g., translation, referenced by a match database token string of the D0 data bucket is presented to the user 574. In this alternate embodiment each solution data referenced by a database token string of the D0 data bucket that is, in turn, referenced by a match similar database token string of a data bucket other than the D0 data bucket is presented to the user. The user is requested to choose a presented solution data, e.g., translation, for the input token string 576. Upon receiving the user chosen solution data, the user chosen solution data is used, or otherwise provided, for the input token string 578.

In a second alternative embodiment, if there is more than one match token string in the database for the current input token string, processing is performed using one or more criteria, such as, but not limited to, frequency of use of a solution data, e.g., translation, associated with a match token string of the database, to select a solution data to be used, or otherwise provided, for the input token string 574.

Referring again to FIG. 5D, if at decision block 564 no match has been identified for the current input token string, in an embodiment, at decision block 565 it is determined whether the set timer, e.g., t, has expired, indicating the time to find a match in the database, and solution data, e.g., a translation, for the input token string, has expired. If the set timer has expired, in an embodiment a user is notified that no solution can be provided for the current input token string 567. In an embodiment processing returns to FIG. 5B, where once again a determination is made as to whether there is currently a new database token string to be added to the database 532.

If the set timer has not expired, referring to FIG. 5F, in an embodiment processing loops are executed to generate similar input token strings for the input token string, which are then compared to the database token strings and similar database token strings of the search database. In an embodiment a first loop with an index, e.g., i, initialized to one (1) 580 is for generating revised, or similar, input token strings from the input token string with a specific, i, distance from the input token string. In an embodiment a second loop with an index, e.g., j, initialized to one (1) 582 is for deleting, or otherwise removing or ignoring, every combination of i number of token(s) from the input token string.

In an embodiment the j^{th} combination of i number of token(s) is deleted, or otherwise removed or ignored, from the input token string to derive a j^{th} similar input token string 584. In an embodiment the j^{th} similar input token string is compared to the database token strings and similar database token strings in the D0 through Dx data bucket(s) 586. Thus, for example, a first single token is deleted, or otherwise removed or ignored, from the input token string and the resultant similar input token string is then compared to the database token strings and similar database token strings within the set acceptable search distance.

At decision block 588 a determination is made as to whether a match to the current similar input token string is in any of the searched data buckets. If yes, then referring again to FIG. 5D in an embodiment processing to identify solution data, e.g., a translation, for the input token string is performed as previously discussed, with first a determination being made as to whether there is more than one match token string in the database for the input token string 566.

If at decision block 588 of FIG. 5F no match has been found for the current similar input token string in an embodiment, at decision block 589 it is determined whether the set timer, e.g., t, has expired, indicating the time to find a match in the database, and a solution for the input token string, has expired. If the set timer has expired, in an embodiment a user is notified that no solution can be provided for the current input token string 591. In an embodiment processing returns to FIG. 5B, where a determination is made as to whether there is currently a new database token string to be added to the database 532.

If at decision block 589 the set timer has not expired in an embodiment the second loop index, e.g., j, is incremented 590 so that the next combination of i number of tokens can be deleted, or otherwise removed or ignored, from the input token string. At decision block 592 a determination is made as to whether or not the second index, e.g., j, is now greater than the number of combinations of i token(s) in the input token string. If no, the new j^{th} combination of i number of token(s) is deleted, or otherwise removed or ignored, from the input token string to derive a new j^{th} similar input token string 584. The new j^{th} similar input token string is then compared to the database token strings and similar database token strings in the D0 through Dx data bucket(s) 586.

At decision block 592 if it is determined that the second index, e.g., j, is now greater than the number of combinations of i token(s) in the input token string, in an embodiment the first loop index, e.g., i, is incremented 594 so that combinations of the new i number of tokens, e.g., combinations of two tokens, combinations of three tokens, etc., can be deleted, or otherwise removed or ignored, from the input token string.

At decision block 596 a determination is made as to whether any further processing to generate similar input token strings would be outside the acceptable search distance. If no, in an embodiment the second index, e.g., j, is reset to one 582 and processing of the input token string continues with the first combination of the new i number of token(s) being deleted, or otherwise removed or ignored, from the input token string to generate a similar input token string 584 to be compared to the database token strings and similar database token strings 586.

If, however, at decision block 596 it is determined that any further processing to generate similar input token strings would be outside the acceptable search distance then in an embodiment the user is notified that no solution can be made for the current input token string. In an embodiment processing returns to the decision block 532 of FIG. 5B, where it is determined whether there is a new database token string to be added to the database.

In an alternate embodiment similar input token strings of the same distance from the original input token string are all generated and simultaneously compared to the database token strings and similar database token strings within the allowed search distance. In yet a second alternative embodiment all similar input token strings of any acceptable search distance are generated and the original input token string and all generated similar input token strings are simultaneously compared to the database token strings and similar database token strings within the allowed search distance.

In embodiments similar token strings with a distance of one are generated by removing one token at a time from a token string, similar token strings with a distance of two are generated by removing a combination of two tokens at a time from a token string, etc. In alternative embodiments other distance gradients can be used. For example, in an alternative embodiment similar token strings with a distance of one are generated by removing ten tokens at a time from a token string, similar token strings with a distance of two are generated by removing one hundred tokens at a time from a token string, etc.

In other alternative embodiments alternative distances are assigned to removal units. For example, in one other such alternative embodiment removing one token, e.g., word, is denoted as a distance of ten.

In alternative embodiments myriad combinations and gradations of distance and identification labeling for the subsequent derived groups of similar token strings can be used.

### Alternative Sub Linear Approximate String Matching Uses

The prior discussion has addressed the application of sub linear approximate string matching most specifically to the problem of computer aided translation. The principles employed for establishing and using embodiment search databases as described herein, e.g., the embodiment search database 200 of FIG. 2, and/or concepts thereof, can be used for myriad other applications

One such alternative application is fingerprint identification, where the database token strings are strings of fingerprint data and the associated solution data designate respective fingerprint owners.

Another alternative application is street address identification, where the database token strings are strings of address information and the associated solution data are location expressions.

A third alternative application is DNA sequencing identification, where the database token strings are strings of DNA information and the associated solution data are DNA sequencing identification.

A fourth alternative application is face recognition, where the database tokens strings are strings of facial feature data and the associated solution data are person identification, or alternatively, human group identification, e.g., child vs. adult, male vs. female, ethnicity, etc.

A fifth alternative application combines typographical error correction with another problem, e.g., CAT, wherein the database token strings are strings of correctly spelled words. In an embodiment of this fifth alternative application the associated solution data is the translations for token strings, e.g., phrases, sentences, paragraphs, etc., as they would be without any typographical, e.g., spelling, errors.

Additional alternative embodiment systems and applications that employ principles explained herein include, but are not limited to, library search systems, employment record databases, etc.

### Computing Device System Configuration

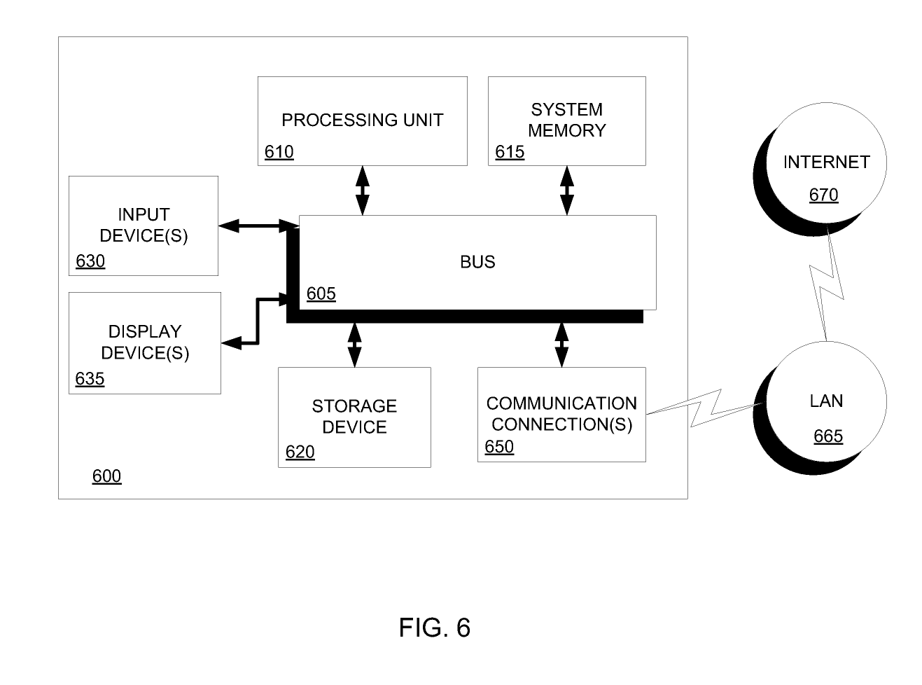

FIG. 6 is a block diagram that illustrates an exemplary computing device system 600 upon which an embodiment can be implemented. The computing device system 600 includes a bus 605 or other mechanism for communicating information, and a processing unit 610 coupled with the bus 605 for processing information. The computing device system 600 also includes system memory 615, which may be volatile or dynamic, such as random access memory (RAM), non-volatile or static, such as read-only memory (ROM) or flash memory, or some combination of the two. The system memory 615 is coupled to the bus 605 for storing information and instructions to be executed by the processing unit 610, and may also be used for storing temporary variables or other intermediate information during the execution of instructions by the processing unit 610. The system memory 615 often contains an operating system and one or more programs, and may also include program data.

In an embodiment, a storage device 620, such as a magnetic or optical disk, is also coupled to the bus 605 for storing information, including program code comprising instructions and/or data.

The computing device system 600 generally includes one or more display devices 635, such as, but not limited to, a display screen, e.g., a cathode ray tube (CRT) or liquid crystal display (LCD), a printer, and one or more speakers, for providing information to a computing device user. The computing device system 600 also generally includes one or more input devices 630, such as, but not limited to, a keyboard, mouse, trackball, pen, voice input device(s), and touch input devices, which a computing device user can use to communicate information and command selections to the processing unit 610. All of these devices are known in the art and need not be discussed at length here.

The processing unit 610 executes one or more sequences of one or more program instructions contained in the system memory 615. These instructions may be read into the system memory 615 from another computing device-readable medium, including, but not limited to, the storage device 620. In alternative embodiments, hard-wired circuitry may be used in place of or in combination with software program instructions. The computing device system environment is not limited to any specific combination of hardware circuitry and/or software.

The term “computing device-readable medium” as used herein refers to any medium that can participate in providing program instructions to the processing unit 610 for execution. Such a medium may take many forms, including but not limited to, storage media and transmission media. Examples of storage media include, but are not limited to, RAM, ROM, EEPROM, flash memory, CD-ROM, digital versatile disks (DVD), magnetic cassettes, magnetic tape, magnetic disk storage, or any other magnetic medium, floppy disks, flexible disks, punch cards, paper tape, or any other physical medium with patterns of holes, memory chip, or cartridge. The system memory 615 and storage device 620 of the computing device system 1000 are further examples of storage media. Examples of transmission media include, but are not limited to, wired media such as coaxial cable(s), copper wire and optical fiber, and wireless media such as optic signals, acoustic signals, RF signals and infrared signals.

The computing device system 600 also includes one or more communication connections 650 coupled to the bus 605. The communication connection(s) 650 provide a two-way data communication coupling from the computing device system 600 to other computing devices on a local area network (LAN) 665 and/or wide area network (WAN), including the World Wide Web, or Internet 670. Examples of the communication connection(s) 650 include, but are not limited to, an integrated services digital network (ISDN) card, modem, LAN card, and any device capable of sending and receiving electrical, electromagnetic, optical, acoustic, RF or infrared signals.

Communications received by the computing device system 600 can include program instructions and program data. The program instructions received by the computing device system 600 may be executed by the processing unit 610 as they are received, and/or stored in the storage device 620 or other non-volatile storage for later execution.

### CONCLUSION

While various embodiments are described herein, these embodiments have been presented by way of example only and are not intended to limit the scope of the claimed subject matter. Many variations are possible which remain within the scope of the following claims. Such variations are clear after inspection of the specification, drawings and claims herein. Accordingly, the breadth and scope of the claimed subject matter is not to be restricted except as defined with the following claims and their equivalents.

What is claimed is:

1. A method for generating a database supportive of sub linear token string matching, the method comprising:
identifying two or more database token strings to be included in the database;
identifying a solution for each database token string;
associating each database token string in a first group of the database;
associating the solution for each database token string with the database token string in the first group of the database;
generating two or more similar token strings with a distance of a first unit by, for each similar token string with a distance of the first unit, deleting a first number of tokens of a first database token string from the first database token string;
associating each generated similar token string with a distance of the first unit in a second group of the database;
associating each generated similar token string with a distance of the first unit with the first database token string in the first group of the database;
generating one or more similar token strings with a distance of a second unit by, for each similar token string with a distance of the second unit, deleting one combination of a second number of tokens of the first database token string from the first database token string;
associating each generated similar token string with a distance of the second unit in a third group of the database; and
associating each generated similar token string with a distance of the second unit with the first database token string in the first group of the database.

2. The method for generating a database supportive of sub linear token string matching of claim 1, wherein associating each database token string in the first group of the database comprises storing each database token string in the database in a manner in which each database token string is identified with the first group of the database, wherein associating each generated similar token string with a distance of the first unit in the second group of the database comprises storing each generated similar token string with a distance of the first unit in the database in a manner in which each generated similar token string with a distance of the first unit is identified with the second group of the database, and wherein associating each generated similar token string with a distance of the second unit in the third group of the database comprises storing each generated similar token string with a distance of the second unit in the database in a manner in which each generated similar token string with a distance of the second unit is identified with the third group of the database.

3. The method for generating a database supportive of sub linear token string matching of claim 1 wherein the two or more database token strings each comprise two or more words and the solution for each database token string comprises a translation for the database token string.

4. The method for generating a database supportive of sub linear token string matching of claim 1 wherein the two or more database token strings each comprise two or more sentences and the solution for each database token string comprises a translation for the database token string.

5. The method for generating a database supportive of sub linear token string matching of claim 4 wherein a first set of similar database token strings is derived by removing one or more sentences from each of the two or more database token strings and wherein a second set of similar database token strings is derived by removing one or more words from each of the two or more sentences of each of the two or more database token strings.

6. The method for generating a database supportive of sub linear token string matching of claim 1, further comprising:
generating a second set of two or more similar token strings with a distance of the first unit by, for each similar token string with a distance of the first unit of the second set, deleting the first number of tokens of a second database token string from the second database token string;
associating each generated similar token string with a distance of the first unit in the second set in the second group of the database;
associating each generated similar token string with a distance of the first unit in the second set with the second database token string in the first group of the database;
generating a second set of one or more similar token strings with a distance of the second unit by, for each similar token string with a distance of the second unit of the second set, deleting one combination of the second number of tokens of the second database token string from the second database token string;
associating each generated similar token string with a distance of the second unit in the second set in the third group of the database; and
associating each generated similar token string with a distance of the second unit in the second set with the second database token string in the first group of the database.

7. The method for generating a database supportive of sub linear token string matching of claim 6, further comprising:
generating a first collection of at least two similar token strings with a distance of the first unit for each database token string other than the first database token string and the second database token string by, for each similar token string with a distance of the first unit of the first collection, deleting a first number of tokens of the database token string from the database token string;
associating each generated similar token string with a distance of the first unit in the first collection in the second group of the database;
associating each generated similar token string with a distance of the first unit in the first collection with the database token string in the first group of the database from which the generated similar token string with a distance of the first unit in the first collection was generated;
generating a second collection of at least two similar token strings with a distance of the second unit for each database token string other than the first database token string and the second database token string by, for each similar token string with a distance of the second unit of the second collection, deleting one unique combination of the second number of tokens of the database token string from the database token string;
associating each generated similar token string with a distance of the second unit in the second collection in the third group of the database; and
associating each generated similar token string with a distance of the second unit in the collection with the database token string in the first group of the database from which the generated similar token string with a distance of the second unit in the second collection was generated.

8. The method for generating a database supportive of sub linear token string matching of claim 7, wherein the first unit is one, the first number of tokens is one, the second unit is two and the second number of tokens is two.

9. A method for computerized problem solving involving token string matching, the method comprising:
comparing an input token string to two or more database token strings of a database, wherein the database is comprised of two or more groups of database token strings and wherein a first group of database token strings is associated with a solution and a second group of database token strings is comprised of database token strings that have been generated by removing a first number of tokens from a database token string of the first group of database token strings;
identifying the solution associated with a first database token string of the first group when the first database token string of the first group is a match to the input token string; and
identifying the solution associated with a first database token string of the first group when the first database token string of the first group is associated with a first database token string of the second group that is a match to the input token string.

10. The method for computerized problem solving of claim 9 wherein the method is for computerized translation, the input token string comprises a string of one or more words to be translated and the solution associated with the first database token string of the first group is the translation for the first database token string of the first group.

11. The method for computerized problem solving of claim 9 wherein the first number of tokens is one.

12. The method for computerized problem solving of claim 9, further comprising:
identifying at least the first database token string of the second group and a second database token string of the second group that are each a match to the input token string, wherein the second database token string of the second group is associated with a second database token string of the first group; and
using one or more criteria to select the first database token string of the first group to be the identified match for the input token string.

13. The method for computerized problem solving of claim 9, further comprising:
identifying at least the first database token string of the second group and a second database token string of the second group that are each a match to the input token string, wherein the second database token string of the second group is associated with a second database token string of the first group;
providing to a user the first database token string of the first group that is associated with the first database token string of the second group that is a match to the input token string;
providing to the user the second database token string of the first group that is associated with the second database token string of the second group that is a match to the input token string; and
receiving a user determination that the solution associated with the first database token string of the first group is the solution to be used.

14. The method for computerized problem solving of claim 9, further comprising:
deriving a similar input token string with a distance of a first unit by removing the first number of tokens from the input token string;
comparing the derived similar input token string with a distance of the first unit to at least one database token string of the first group;
comparing the derived similar input token string with a distance of the first unit to at least one database token string of the second group; and
using the solution associated with the database token string of the first group that is associated with the database token string of the second group that is compared to the derived similar input token string with a distance of the first unit when the database token string of the second group that is compared to the derived similar input token string with a distance of the first unit is a match to the derived similar input token string with a distance of the first unit.

15. The method for computerized problem solving of claim 9, further comprising:
deriving a set of similar input token strings with a distance of the first unit by, for each derived similar input token string of the set, removing a first number of tokens from the input token string;
comparing each of the set of similar input token strings with a distance of the first unit to each database token string of the first group; and
comparing each of the set of similar input token strings with a distance of the first unit to each database token string of the second group when an acceptable match is at least a distance of the first unit.

16. The method for computerized problem solving of claim 15, further comprising:
establishing a time limit; and
notifying a user that no solution can be produced for the input token string when the established time limit expires and no match has been identified for the input token string in the database of two or more database token strings and no match has been identified for any similar input token string with a distance of the first unit in the database of two or more database token strings.

17. A method for problem solving involving token string matching, the method comprising:
comparing an input token string to be matched to two or more database token strings of a database, wherein the database is comprised of two or more groups of database token strings and wherein a first group of database token strings is associated with a solution and a second group of database token strings is comprised of database token strings that have been derived by removing one token from a database token string of the first group of database token strings;
deriving one or more similar input token strings with a distance of one by removing each token, one at a time, from the input token string;
comparing one or more of the similar input token strings with a distance of one to at least one database token string in the first group of database token strings;
comparing one or more of the similar input token strings with a distance of one to at least one database token string in the second group of database token strings;
identifying the solution associated with a first database token string of the first group when the first database token string of the first group is a match to a similar input token string with a distance of one; and
identifying the solution associated with a first database token string of the first group when the first database token string of the first group is associated with a first database token string of the second group that is a match to a similar input token string with a distance of one.

18. The method for problem solving involving token string matching of claim 17, wherein the database is comprised of at least three groups of database token strings and wherein a third group of database token strings is comprised of database token strings that have been derived by removing one combination of two tokens from a database token string of the first group, the method further comprising:
deriving a similar input token string with a distance of two if an acceptable distance for a match for the input token string comprises two, wherein the similar input token string with a distance of two is derived by removing one combination of two tokens from the input token string; and
comparing the derived similar input token string with a distance of two to at least one database token string of the first group.

19. The method for problem solving involving token string matching of claim 18, further comprising:
deriving a set of similar input token strings with a distance of two wherein each of the set of similar input token strings with a distance of two is derived by removing one unique combination of two tokens from the input string;
comparing each of the set of similar input token strings with a distance of two to at least one database token string of the first group;
comparing each of the set of similar input token strings with a distance of two to at least one database token string of the second group; and
comparing each of the set of similar input token strings with a distance of two to at least one database token string of the third group.

20. The method for computerized problem solving of claim 17, further comprising:
establishing a time limit; and
notifying a user that no solution can be produced for the input token string when the established time limit expires and no match has been identified for the input token string in the database.
